(19) United States
(12) Patent Application Publication
(10) Pub. No.: US 2025/0159588 A1
(43) Pub. Date: May 15, 2025

(54) ON-DEMAND NON-CELL-DEFINING SYNCHRONIZATION SIGNAL BLOCK TRANSMISSION

(71) Applicant: QUALCOMM Incorporated, San Diego, CA (US)

(72) Inventors: Sambit BEHURA, Hyderabad (IN); Nazmul ISLAM, Littleton, MA (US); Ishdeep Singh JUNEJA, Hyderabad (IN); Varun WALIA, Hyderabad (IN)

(21) Appl. No.: 18/506,365

(22) Filed: Nov. 10, 2023

(51) Int. Cl. H04W 48/08; H04W 72/20

(52) U.S. Cl. CPC H04W 48/08; H04W 72/20

(57) ABSTRACT

Methods, systems, and devices for wireless communication are described. In some systems, a network entity may transmit, to a user equipment (UE), control signaling that configures an on-demand transmission scheme a first synchronization signal block (SSB) for a cell via one or more transmission opportunities within an operating bandwidth of the UE. The cell may be associated with a carrier bandwidth that includes the operating bandwidth of the UE. The UE may transmit a message that requests transmission of one or more instances of the first SSB. The network entity may transmit the one or more instances of the first SSB based on the message. The one or more instances may be transmitted in the operating bandwidth of the UE and via at least one of the one or more transmission opportunities.

### FIELD OF TECHNOLOGY

The following relates to wireless communication, including on-demand non-cell-defining (NCD) synchronization signal block (SSB) transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, a network entity may transmit a synchronization signal block (SSB) via a carrier bandwidth of a cell. The SSB may be associated with system information for the cell, such as a system information block (SIB). The UE may measure the SSB for communications within the cell.

### SUMMARY

The described techniques relate to improved methods, systems, devices, and apparatuses that support on-demand non-cell-defining (NCD) synchronization signal block (SSB) transmission. For example, the described techniques provide for a network entity to configure an on-demand NCD-SSB transmission scheme (e.g., enable on-demand NCD-SSB transmission), and for a user equipment (UE) to request the NCD-SSB in accordance with the on-demand configuration. The network entity may transmit control signaling that configures the on-demand NCD-SSB transmission scheme. The control signaling may indicate a set of transmission occasions within an operating bandwidth of the UE that are allocated for the NCD-SSB. The network entity may refrain from transmitting the NCD-SSB until the network entity receives a request, which may reduce overhead as compared with systems in which the network entity periodically transmits the NCD-SSB. The UE may periodically transition to a second frequency that is external to an operating frequency of the UE, but within a carrier frequency for a cell, to monitor for a cell-defining SSB (CD-SSB) within one or more measurement gaps. If the UE detects that more frequent SSB measurements may be beneficial, the UE may transmit a message that requests a quantity of one or more NCD-SSBs. The network entity may transmit at least the quantity of one or more NCD-SSBs via the transmission occasions in the operating bandwidth of the UE based on the request. The UE may monitor for and measure the quantity of NCD-SSBs, and the UE may subsequently return to periodically monitoring for the CD-SSB. The UE may thereby request a burst of NCD-SSB transmissions that are more frequent than the CD-SSB transmissions to improve communication reliability and throughput while reducing overhead.

A method for wireless communication by a UE is described. The method may include receiving control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE, transmitting, in accordance with the on-demand transmission scheme, a message requesting transmission of one or more instances of the first SSB, and receiving, based on the message, the one or more instances of the first SSB in the operating bandwidth of the UE via at least one transmission opportunity of the set of multiple transmission opportunities.

A UE for wireless communication is described. The UE may include one or more memories storing processor executable code, and one or more processors coupled with the one or more memories. The one or more processors may individually or collectively operable to execute the code to cause the UE to receive control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE, transmit, in accordance with the on-demand transmission scheme, a message requesting transmission of one or more instances of the first SSB, and receive, based on the message, the one or more instances of the first SSB in the operating bandwidth of the UE via at least one transmission opportunity of the set of multiple transmission opportunities.

Another UE for wireless communication is described. The UE may include means for receiving control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE, means for transmitting, in accordance with the on-demand transmission scheme, a message requesting transmission of one or more instances of the first SSB, and means for receiving, based on the message, the one or more instances of the first SSB in the operating bandwidth of the UE via at least one transmission opportunity of the set of multiple transmission opportunities.

A non-transitory computer-readable medium storing code for wireless communication is described. The code may include instructions executable by a processor to receive control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE, transmit, in accordance with the on-demand transmission scheme, a message requesting transmission of one or more instances of the first SSB, and receive, based on the message, the one or more instances of the first SSB in the operating bandwidth of the UE via at least one transmission opportunity of the set of multiple transmission opportunities.

In some examples of the method, UE, and non-transitory computer-readable medium described herein, receiving the control signaling may include operations, features, means, or instructions for receiving, via the control signaling, an indication of a quantity of slots between the message and a first instance of the one or more instances of the first SSB, where the first instance may be received at least the quantity of slots after the message may be transmitted.

In some examples of the method, UE, and non-transitory computer-readable medium described herein, transmitting the message may include operations, features, means, or instructions for transmitting, via the message, an indication of a quantity of instances requested by the UE, where the one or more instances of the first SSB include the quantity of instances based on the message.

In some examples of the method, UE, and non-transitory computer-readable medium described herein, transmitting the message may include operations, features, means, or instructions for transmitting, via the message, a selection request that requests for a network entity to select a default quantity of the one or more instances, where the one or more instances include the default quantity of instances based on the selection request.

In some examples of the method, UE, and non-transitory computer-readable medium described herein, receiving the control signaling may include operations, features, means, or instructions for receiving, via the control signaling, an indication of the default quantity of instances of the first SSB.

In some examples of the method, UE, and non-transitory computer-readable medium described herein, receiving the one or more instances of the first SSB may include operations, features, means, or instructions for receiving, via a first set of transmission opportunities from the set of multiple transmission opportunities, a set of multiple instances of the first SSB based on the default quantity of instances being associated with a semi-persistent transmission pattern, monitoring a second set of one or more transmission opportunities of the set of multiple transmission opportunities, and transitioning, after monitoring a threshold quantity of the second set of one or more transmission opportunities that exclude the first SSB, to periodically monitoring a second frequency in the carrier bandwidth for a second SSB that may be associated with system information of the cell, the second frequency external to the operating bandwidth of the UE.

Some examples of the method, UE, and non-transitory computer-readable medium described herein may further include operations, features, means, or instructions for transmitting a capability message that indicates a capability of the UE to support on-demand SSB communications, where receiving the control signaling may be based on the capability message.

In some examples of the method, UE, and non-transitory computer-readable medium described herein, periodically monitoring a second frequency in the carrier bandwidth for a second SSB that may be associated with system information of the cell, the second frequency external to the operating bandwidth of the UE, where transmitting the message may be based on a change in one or more conditions associated with the second SSB.

In some examples of the method, UE, and non-transitory computer-readable medium described herein, the change in the one or more conditions includes a timing drift of beams associated with the second SSB, or a change in a beam pair link, or both.

Some examples of the method, UE, and non-transitory computer-readable medium described herein may further include operations, features, means, or instructions for evaluating one or more communication metrics during a first time period based on monitoring the second frequency for the second SSB and evaluating the one or more communication metrics during a second time period based on receiving the one or more instances of the first SSB, where the second time period may be longer than the first time period.

In some examples of the method, UE, and non-transitory computer-readable medium described herein, periodically monitoring, after receiving the one or more instances of the first SSB, a second frequency in the carrier bandwidth for a second SSB that may be associated with system information of the cell, the second frequency external to the operating bandwidth of the UE.

In some examples of the method, UE, and non-transitory computer-readable medium described herein, receiving the control signaling may include operations, features, means, or instructions for receiving, via the control signaling, an indication of a frequency associated with the first SSB, a periodicity associated with the first SSB, a time offset associated with the first SSB, or any combination thereof, where the frequency may be within the operating bandwidth of the UE.

In some examples of the method, UE, and non-transitory computer-readable medium described herein, a logical channel identifier (LCID) of the message indicates a request for transmission of the one or more instances of the first SSB.

In some examples of the method, UE, and non-transitory computer-readable medium described herein, the control signaling includes radio resource control (RRC) signaling and the message includes a medium access control-control element (MAC-CE).

In some examples of the method, UE, and non-transitory computer-readable medium described herein, the first SSB may be different from a second SSB that may be associated with system information of the cell, the first SSB including an NCD-SSB and the second SSB including a CD-SSB.

A method for wireless communication by a network entity is described. The method may include transmitting control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE, receiving, in accordance with the on-demand transmission scheme, a message requesting transmission of one or more instances of the first SSB, and transmitting, based on the message, the one or more instances of the first SSB in the operating bandwidth of the UE via at least one transmission opportunity of the set of multiple transmission opportunities.

A network entity for wireless communication is described. The network entity may include one or more memories storing processor executable code, and one or more processors coupled with the one or more memories. The one or more processors may individually or collectively operable to execute the code to cause the network entity to transmit control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE, receive, in accordance with the on-demand transmission scheme, a message requesting transmission of one or more instances of the first SSB, and transmit, based on the message, the one or more instances of the first SSB in the operating bandwidth of the UE via at least one transmission opportunity of the set of multiple transmission opportunities.

Another network entity for wireless communication is described. The network entity may include means for transmitting control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE, means for receiving, in accordance with the on-demand transmission scheme, a message requesting transmission of one or more instances of the first SSB, and means for transmitting, based on the message, the one or more instances of the first SSB in the operating bandwidth of the UE via at least one transmission opportunity of the set of multiple transmission opportunities.

A non-transitory computer-readable medium storing code for wireless communication is described. The code may include instructions executable by a processor to transmit control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE, receive, in accordance with the on-demand transmission scheme, a message requesting transmission of one or more instances of the first SSB, and transmit, based on the message, the one or more instances of the first SSB in the operating bandwidth of the UE via at least one transmission opportunity of the set of multiple transmission opportunities.

In some examples of the method, network entities, and non-transitory computer-readable medium described herein, transmitting the control signaling may include operations, features, means, or instructions for transmitting, via the control signaling, an indication of a threshold quantity of slots between the message and a first instance of the one or more instances of the first SSB, where the first instance may be transmitted at least the threshold quantity of slots after the message may be received.

In some examples of the method, network entities, and non-transitory computer-readable medium described herein, receiving the message may include operations, features, means, or instructions for receiving, via the message, an indication of a quantity of instances requested by the UE, where the one or more instances of the first SSB include the quantity of instances based on the message.

In some examples of the method, network entities, and non-transitory computer-readable medium described herein, receiving the message may include operations, features, means, or instructions for receiving, via the message, a selection request that requests for the network entity to select a default quantity of the one or more instances, where the one or more instances include the default quantity of instances based on the selection request.

In some examples of the method, network entities, and non-transitory computer-readable medium described herein, transmitting the control signaling may include operations, features, means, or instructions for transmitting, via the control signaling, an indication of the default quantity of instances of the first SSB.

In some examples of the method, network entities, and non-transitory computer-readable medium described herein, transmitting the one or more instances of the first SSB may include operations, features, means, or instructions for transmitting, via a first set of transmission opportunities from the set of multiple transmission opportunities, a set of multiple instances of the first SSB based on the default quantity of instances being associated with a semi-persistent transmission pattern, where the control signaling indicates that the default quantity of instances may be associated with the semi-persistent transmission pattern.

Some examples of the method, network entities, and non-transitory computer-readable medium described herein may further include operations, features, means, or instructions for receiving a capability message that indicates a capability of the UE to support on-demand SSB communications, where transmitting the control signaling may be based on the capability message.

In some examples of the method, network entities, and non-transitory computer-readable medium described herein, periodically transmitting, via a second frequency in the carrier bandwidth, a second SSB that may be associated with system information of the cell, the second frequency external to the operating bandwidth of the UE.

In some examples of the method, network entities, and non-transitory computer-readable medium described herein, periodically transmitting, after transmitting the one or more instances of the first SSB and via a second frequency in the carrier bandwidth, a second SSB that may be associated with system information of the cell, the second frequency external to the operating bandwidth of the UE.

In some examples of the method, network entities, and non-transitory computer-readable medium described herein, transmitting the control signaling may include operations, features, means, or instructions for transmitting, via the control signaling, an indication of a frequency associated with the first SSB, a periodicity associated with the first SSB, a time offset associated with the first SSB, or any combination thereof, where the frequency may be within the operating bandwidth of the UE.

Some examples of the method, network entities, and non-transitory computer-readable medium described herein may further include operations, features, means, or instructions for refraining from transmitting the first SSB before receiving the message based on the control signaling configuring the on-demand transmission scheme for the first SSB.

In some examples of the method, network entities, and non-transitory computer-readable medium described herein, an LCID of the message indicates a request for transmission of the one or more instances of the first SSB.

In some examples of the method, network entities, and non-transitory computer-readable medium described herein, the control signaling includes RRC signaling and the message includes a MAC-CE.

In some examples of the method, network entities, and non-transitory computer-readable medium described herein, the first SSB may be different from a second SSB that may be associated with system information of the cell, the first SSB including an NCD-SSB and the second SSB including a CD-SSB.

### BRIEF DESCRIPTION OF THE DRAWINGS

FIG. 1 shows an example of a wireless communications system that supports on-demand non-cell-defining (NCD) synchronization signal block (SSB) transmission in accordance with one or more aspects of the present disclosure.

FIG. 2 shows an example of a wireless communications system that supports on-demand NCD-SSB transmission in accordance with one or more aspects of the present disclosure.

FIG. 3 shows an example of a medium access control-control element (MAC-CE) configuration that supports on-demand NCD-SSB transmission in accordance with one or more aspects of the present disclosure.

FIG. 4 shows an example of a communication timeline that supports on-demand NCD-SSB transmission in accordance with one or more aspects of the present disclosure.

FIG. 5 shows an example of a flow diagram that supports on-demand NCD-SSB transmission in accordance with one or more aspects of the present disclosure.

FIG. 6 shows an example of a process flow that supports on-demand NCD-SSB transmission in accordance with one or more aspects of the present disclosure.

FIGS. 7 and 8 show block diagrams of devices that support on-demand NCD-SSB transmission in accordance with one or more aspects of the present disclosure.

FIG. 9 shows a block diagram of a communications manager that supports on-demand NCD-SSB transmission in accordance with one or more aspects of the present disclosure.

FIG. 10 shows a diagram of a system including a device that supports on-demand NCD-SSB transmission in accordance with one or more aspects of the present disclosure.

FIGS. 11 and 12 show block diagrams of devices that support on-demand NCD-SSB transmission in accordance with one or more aspects of the present disclosure.

FIG. 13 shows a block diagram of a communications manager that supports on-demand NCD-SSB transmission in accordance with one or more aspects of the present disclosure.

FIG. 14 shows a diagram of a system including a device that supports on-demand NCD-SSB transmission in accordance with one or more aspects of the present disclosure.

FIGS. 15 through 18 show flowcharts illustrating methods that support on-demand NCD-SSB transmission in accordance with one or more aspects of the present disclosure.

### DETAILED DESCRIPTION

In some wireless communications systems, a user equipment (UE) may operate in a narrower bandwidth (e.g., a bandwidth part (BWP)) than a serving cell bandwidth to reduce power consumption. The UE may monitor for and perform measurements on synchronization signal blocks (SSBs) transmitted by a network entity for purposes such as beam management, radio resource management, tracking, and radio link monitoring. The network entity may transmit a cell defining SSB (CD-SSB) periodically. The CD-SSB may be transmitted outside of the operating bandwidth of the UE and may be associated with system information for a cell. Accordingly, in some examples, the UE may be configured to periodically switch from the narrow operating bandwidth of the UE to the bandwidth in which the CD-SSB is transmitted in order to monitor for the CD-SSB. However, such switching may increase latency due to, for example, timing drifts or changes in beam configurations. In some other examples, periodic non-cell-defining SSBs (NCD-SSBs) may be configured in the operating bandwidth of the UE. Configuring and transmitting periodic NCD-SSBs for each UE, however, may increase control resource overhead.

Techniques described herein provide for a network entity to configure on-demand NCD-SSB transmission. The network entity may transmit control signaling that enables on-demand NCD-SSB via a set of transmission occasions within an operating bandwidth of a UE. Enabling the on-demand NCD-SSB may include configuring an on-demand NCD-SSB transmission scheme in which the network entity may refrain from transmitting the NCD-SSB until the network entity receives a request, which may reduce overhead as compared with systems in which the network entity periodically transmits the NCD-SSB. The UE may thereby request, when the UE detects a need for more frequent SSBs, that the network entity transmits the NCD-SSB(s). For example, the UE may transmit a medium access control-control element (MAC-CE) that indicates the request and a quantity of one or more NCD-SSBs. The network entity may transmit at least the quantity of one or more NCD-SSBs via the transmission occasions in the UE's operating bandwidth based on the request. Once the network entity transmits the quantity of one or more NCD-SSBs, the UE may return to periodically transitioning to a frequency band outside of the UE's operating bandwidth to monitor for CD-SSBs.

Aspects of the disclosure are initially described in the context of wireless communications systems. Additional aspects are described with reference to MAC-CE configurations, communication timelines, process flows, and flow diagrams. Aspects of the disclosure are further illustrated by and described with reference to apparatus diagrams, system diagrams, and flowcharts that relate to on-demand NCD-SSB transmission.

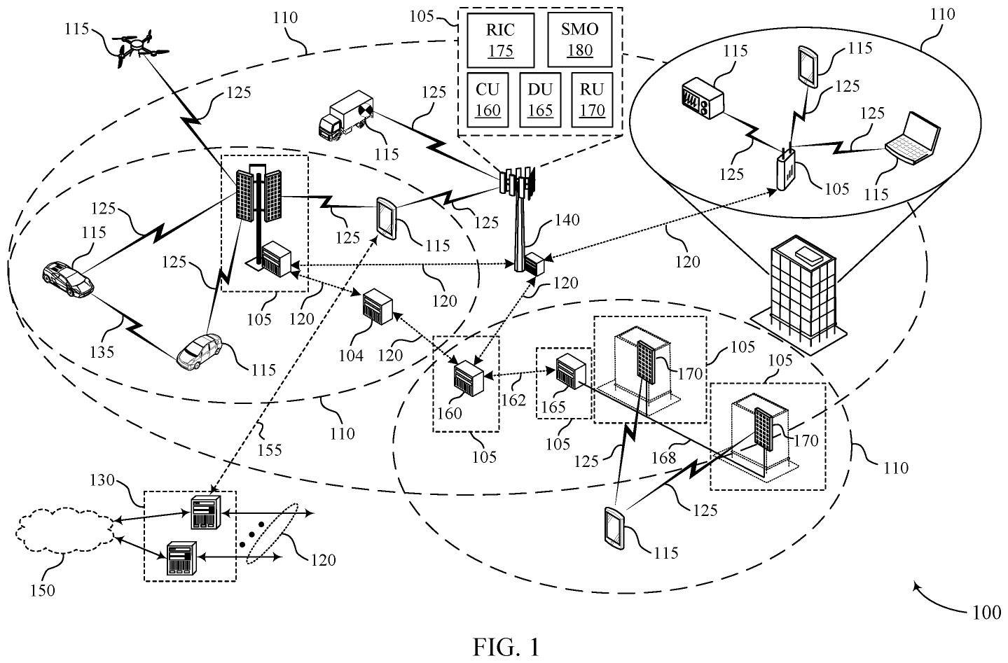

FIG. 1 shows an example of a wireless communications system 100 that supports on-demand NCD-SSB transmission in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support on-demand NCD-SSB transmission as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a serving cell bandwidth for a cell associated with the UE 115 may be larger than the operating BWP. For example, the serving cell bandwidth may be up to 100 MHz for a first frequency range or up to 400 MHz for a second frequency range, or any other bandwidth. A UE 115 may be configured to operate in a narrow BWP to reduce power consumption. For example, the UE 115 may be configured to operate in a BWP that does not include a CD-SSB and an initial, cell-defining control resource set (CORESET) (e.g., CORESET0). The UE 115 may receive an indication of such a configuration via control signaling (e.g., via a parameter, such as bwp-WithoutRestriction, or some other parameter) from a network entity 105, and the configuration may indicate support of BWP operation without bandwidth restriction. The bandwidth restriction in terms of downlink BWP for a primary cell (PCell) and/or a primary/secondary cell (PSCell) means that the bandwidth of a UE-specified RRC configured downlink BWP may not include the bandwidth of CORESET0 (if configured) and the CD-SSB. For secondary cells (SCells), the bandwidth restriction may mean that the bandwidth of the downlink BWP may not include the CD-SSB.

In such cases, the UE 115 may measure the CD-SSB outside of the operating BWP of the UE 115 via measurement gaps. The UE 115 may switch from the operating BWP to another frequency to measure the CD-SSB within one or more measurement gaps. The measurements may be used for tracking, beam management, radio link management, beam failure detection, or any combination thereof. The measurement gaps may be associated with relatively large periodicities (e.g., up to 160 milliseconds, or some other periodicity), and the UE 115 may share the measurement gaps with other measurements, such as measurement objects of other frequency carriers. As such, the frequency at which the UE 115 may track the CD-SSB may be relatively low. The UE 115 may experience timing drift for the CD-SSB beams when measured with low frequency, or a suitable beam link pair with a network entity 105 may change between measurement gaps because the UE 115 changed its subarray or a current beam pair link is associated with blockage.

In some examples, a network entity 105 may transmit a periodic NCD-SSB, which may be configured in BWPs which do not contain the CD-SSB. For example, the network entity 105 may transmit the NCD-SSB via the operating BWP of the UE 115. The network entity 105 may, in some examples, transmit the NCD-SSB periodically, which may give rise to relatively large overhead within the BWP and/or cell. In some other examples, the network entity may transmit one or more reference signals periodically via the operating BWP of the UE 115. The reference signals may include, for example, channel state information (CSI) reference signals (CSI-RSs), tracking reference signals (TRSs), or both. The reference signals may be for measurement by the UE 115 for beam management, radio link management, beam failure detection, and the like (e.g., reference signals configured for connected mode operations). The frequent reference signal transmissions may increase overhead within the BWP, may not be supported by various network infrastructures, may not be supported by one or more types of UE 115, or any combination thereof. As described herein, techniques for a UE 115 to request the NCD-SSB on-demand within the BWP may reduce network overhead, improve efficiency and reliability of beam management and tracking operations at the UE 115, or both.

Techniques described herein provide for a network entity 105 to configure on-demand NCD-SSB transmission. The network entity 105 may transmit control signaling that enables on-demand NCD-SSB via a set of transmission occasions within an operating bandwidth of a UE 115. The network entity 105 may configure a relatively short periodicity for the NCD-SSB over a relatively short duration (e.g., an NCD-SSB burst), such that the UE 115 may perform more frequent measurements within the operating BWP. If on-demand NCD-SSB is enabled, the network entity 105 may refrain from transmitting the NCD-SSB until the network entity 105 receives a request, which may reduce overhead as compared with systems in which the network entity periodically transmits the NCD-SSB. The UE 115 may thereby request, when the UE 115 detects a need for more frequent SSBs, that the network entity 105 transmits the NCD-SSB(s). For example, the UE 115 may transmit a MAC-CE that indicates the request and a quantity of one or more NCD-SSBs. The network entity 105 may transmit at least the quantity of one or more NCD-SSBs via the transmission occasions in the operating bandwidth based on the request. Once the network entity 105 transmits the quantity of one or more NCD-SSBs, the UE 115 may return to periodically transitioning to a frequency band outside of the operating bandwidth to monitor for CD-SSBs.

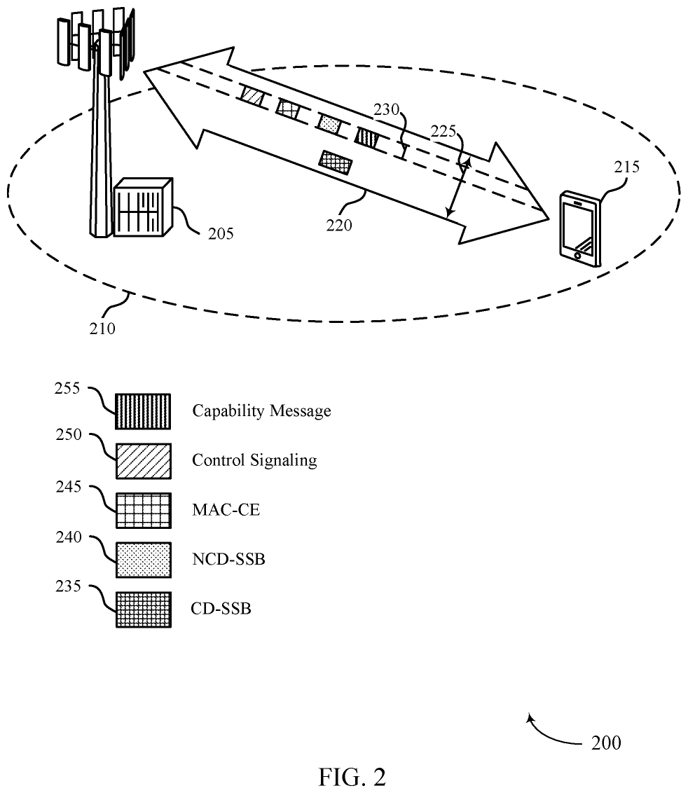

FIG. 2 shows an example of a wireless communications system 200 that supports on-demand NCD-SSB transmission in accordance with one or more aspects of the present disclosure. The wireless communications system 200 may include a network entity 205 and a UE 215, which may represent examples of a network entity 105 and a UE 115, as described with reference to FIG. 1. The network entity 205 and the UE 215 may communicate within geographic coverage area 210 and via a communication link 220 (e.g., a Uu link). The UE 215 may support a reduced operating bandwidth. In some examples, the network entity 205 may configure on-demand transmission of an SSB within the operating bandwidth of the UE 215.

The network entity 205 and the UE 115 may establish communications via a cell. The cell may be associated with a carrier bandwidth 225, which may also be referred to as a system bandwidth, and, in some examples, the carrier bandwidth 225 may be relatively large. For example, the carrier bandwidth 225 may be up to 100 MHZ, or some other relatively large range of frequencies. To reduce power consumption, the UE 215 may be configured with an operating bandwidth 230 that is less than the carrier bandwidth 225. The operating bandwidth 230 may be included within the carrier bandwidth 225 and may be some reduced range of frequencies that the UE 215 may monitor for communications.

As described with reference to FIG. 1, in some examples, a CD-SSB 235 may be configured within the carrier bandwidth 225 but outside of the operating bandwidth 230. The network entity 205 may transmit, via an RRC message, or some other type of control signaling, an indication of one or more periodic transmission occasions for the CD-SSB 235 within the carrier bandwidth 225. The CD-SSB 235 may be an SSB that is associated with system information for the cell (e.g., that points to or maps to a SIB-1 for the cell). To reduce timing delays and overhead associated with the UE 215 periodically transitioning out of the operating bandwidth 230 to monitor for the CD-SSB 235, the network entity 205 may, in some examples, transmit a periodic SSB with the operating bandwidth 230. The SSB may be referred to as an NCD-SSB 240. However, the NCD-SSB 240 may be associated with increased overhead.

As described herein, the network entity 205 may provide an on-demand NCD-SSB configuration. The network entity 205 may transmit control signaling 250 that indicates or includes the on-demand NCD-SSB configuration. The control signaling 250 may be, for example, an RRC message, or some other type of over-the-air configuration. The control signaling 250 may enable on-demand transmission of an NCD-SSB 240 for a cell via one or more transmission opportunities within the operating bandwidth 230 of the UE 215. The control signaling 250 may enable (e.g., or disable) the on-demand configuration, may indicate a quantity of slots associated with requesting on-demand transmission (e.g., nSlotsAdvance), may indicate a default quantity of consecutive SSB bursts (e.g., n-SS-Bursts-NCDSSB), or any combination thereof. In some examples, the on-demand NCD-SSB configuration may be conveyed via an information element within the control signaling 250. In some examples, the information element may be included within a sub-structure of another information element for configuring the NCD-SSB 240. An example structure for such an information element is shown below.

| NonCellDefiningSSB-r17::= SEQUENCE { | |
|---|---|
| absoluteFrequencySSB-r17 | ARFCN-ValueNR, |
| ssb-Periodicity-r17 | ENUMERATED { ms5, ms10, ms20, |
| | ms40, ms80, ms160, spare2, spare1 } |
| ssb-TimeOffset-r17 | ENUMERATED { ms5, ms10, ms15, |
| | ms20, ms40, ms80, spare2, spare1 } |
| RequestOnDemand | SetupRelease {RequestOnDemand- |
| | NonCellDefiningSSB} |
| . | |
| } | |
| RequestOnDemand-NonCellDefiningSSB::= SEQUENCE { | |
| OnDemand-NonCellDefiningSSB | ENUMERATED {True} |
| nSlots Advance | ENUMERATED {n2, n4, n6, |
| | n8, n10, n12, n14, n16, n18} |
| n-SS-Bursts-NCDSSB | ENUMERATED {n1, n2, n4, |
| | n8, n16, n32, n64, |
| | nContTxUntilDeact} |

.
}

In this example, the control signaling 250 may include the NonCellDefiningSSB-r17 information element, which may indicate a frequency for the NCD-SSB 240, a periodicity for the NCD-SSB 240, a time offset for the NCD-SSB 240, a pointer to an on-demand NCD-SSB configuration, or any combination thereof. The on-demand NCD-SSB configuration (e.g., RequestOnDemand) may point to a second information element. The second information element (e.g., the RequestOnDemand-NonCellDefiningSSB information element) may indicate whether on-demand NCD-SSB transmission is enabled or not, a threshold quantity of slots (e.g., nSlotsAdvance), a default quantity of consecutive NCD-SSB bursts (e.g., n-SS-Bursts-NCDSSB), or any combination thereof. It is to be understood that the information element is shown for exemplary purposes, and the NCD-SSB configuration, the on-demand NCD-SSB configuration, or both may be conveyed via any type of control signaling 250 and in any format or structure.

The control signaling 250 may thereby indicate whether on-demand transmission is enabled and one or more parameters for the NCD-SSB 240 if on-demand transmission is enabled. In some examples, the control signaling 250 may configure a set of potential transmission occasions within the operating bandwidth 230 for transmission of the NCD-SSB 240. For example, periodic sets of time and frequency resources in the operating bandwidth 230 may be reserved for potential NCD-SSB transmission, if requested by the UE 215.

In some examples, the UE 215 may transmit a capability message 255 that indicates whether the UE 215 supports the on-demand NCD-SSB transmission. The capability message 255 may include capability information that indicates the capability. The network entity 205 may enable on-demand NCD-SSB if the UE 215 indicates support for the feature, and may not enable on-demand NCD-SSB if the UE 215 does not support the feature.

The network entity 205 may refrain from transmitting the NCD-SSB 240 by default within the operating bandwidth 230 if the on-demand NCD-SSB configuration is enabled (e.g., when “RequestOnDemand” is setup and “OnDemand-NonCellDefiningSSB” is set to True). Instead, to conserve power and reduce overhead, the network entity 205 may wait to transmit the NCD-SSB 240 until the network entity 205 receives a request from the UE 215.

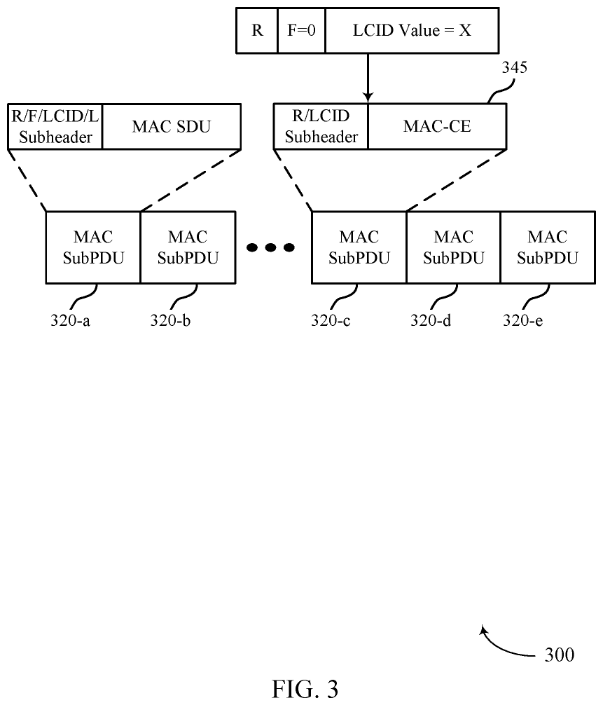

The UE 215 may transmit a message that requests transmission of the NCD-SSB 240 within the operating bandwidth 230. The message may be, for example, a MAC-CE 245, or some other type of message. The UE 215 may transmit the MAC-CE 245 at least a threshold quantity of slots before a first slot (e.g., Slot 0) of a first NCD-SSB transmission. The threshold quantity of slots may be indicated via the control signaling 250 (e.g., nSlotsAdvance). An identifier (ID) of the MAC-CE 245 may indicate that the UE 215 is requesting transmission of the NCD-SSB 240. The MAC-CE 245 may include one or more parameters associated with the NCD-SSB 240. For example, the MAC-CE 245 may indicate a quantity of instances of the NCD-SSB 240 that the UE 215 wants to receive. The MAC-CE payload and format are described in further detail elsewhere herein, including with reference to FIG. 3.

The UE 215 may track and measure the CD-SSB 235 in the carrier bandwidth 225 using inter-frequency measurement gaps with a sharing factor to account for other measurements. For example, the UE 215 may periodically transition to a frequency outside of the operating bandwidth 230 to measure the CD-SSB 235. If the UE 215 detects a need for more frequent SSB tracking and reception, the UE 215 may request the on-demand NCD-SSB 240. The UE 215 may detect the need for more frequent SSB tracking if, for example, the UE 215 identifies a timing drift for the CD-SSB beams or a change in a suitable beam pair link with the network entity 205, or some other parameter or condition that indicates the UE 215 may need more information from the network entity 205 to ensure reliable communications.

The UE 215 may transmit the MAC-CE 245 to request the NCD-SSB 240 in response to identifying the need for more frequent SSB transmissions. Once the network entity 205 receives the request, the network entity 205 may transmit, after at least the threshold quantity of slots, a first instance of the NCD-SSB 240. The network entity 205 may transmit one or more instances of the NCD-SSB 240, where a quantity of the instances that are transmitted may be based on information indicated via the MAC-CE 245. While transmitting the on-demand NCD-SSB(s) 240, the network entity 205 may refrain from other transmissions for other downlink channels (e.g., physical downlink control channel (PDCCH) or a physical downlink shared channel (PDSCH)) over the SSB resource blocks and symbols for the UE 215 and/or other UEs 215 in the cell.

The network entity 205 may thereby reduce overhead and power consumption by enabling on-demand NCD-SSB transmission. The UE 215 may monitor tracking information and reliability and may request the on-demand NCD-SSB 240 when the UE 215 detects a need for more frequent SSBs. The network entity 205 and the UE 215 may thereby maintain reliable communications with reduced overhead.

FIG. 3 shows an example of a MAC-CE configuration 300 that supports on-demand NCD-SSB transmission in accordance with one or more aspects of the present disclosure. In some examples, the MAC-CE configuration 300 may implement or be implemented by aspects of the wireless communications systems 100 and 200. For example, the MAC-CE configuration 300 illustrates a format of a MAC-CE 345 that may indicate a request, by a UE, for an on-demand NCD-SSB transmission. The UE may transmit the MAC-CE 345 to a network entity. The UE and the network entity may represent examples of corresponding devices, as described with reference to FIGS. 1 and 2.

The network entity may configure the UE with on-demand NCD-SSB transmission, as described with reference to FIG. 2. As such, the network entity may refrain from transmitting an NCD-SSB until the network entity receives a request. As described with reference to FIG. 2, the UE may periodically switch from an operating bandwidth of the UE to another frequency that is external to the operating bandwidth in the frequency domain, but within a carrier bandwidth, to monitor for and measure a CD-SSB. The UE may switch to the other frequency during periodic measurement gaps, and the UE may share the measurement gaps with other operations/measurements. As such, the UE may not measure the CD-SSB frequently. If the UE detects any condition or measurement that indicates the UE would benefit from more frequent SSB measurement, the UE may transmit a MAC-CE 345 that requests for one or more instances of an NCD-SSB within the UE's operating bandwidth. The UE may measure the NCD-SSB instance(s) more frequently within the operating bandwidth than the UE measures the CD-SSB, which may provide for more accurate and reliable measurement information at the UE.

The MAC-CE 345 may be transmitted via an uplink packet data unit (PDU) transmission via an uplink data or control channel. The PDU may include one or more MAC sub-PDUs 320. In some examples, the MAC sub-PDU 320-a may include a MAC service data unit (SDU), and may include a subheader and the MAC SDU. The MAC sub-PDU 320-b may also include an SDU. The MAC sub-PDU 320-c may include the MAC-CE 345 requesting NCD-SSB transmission. The MAC-CE 345 may be a fixed size MAC-CE, in some examples (e.g., eight bits, or some other size). The MAC sub-PDU 320-d may include another MAC-CE, which may be a variable-size MAC-CE, in some examples. The MAC sub-PDU 320-e may include padding, in some examples.

The UE may transmit at least the MAC sub-PDU 320-c when requesting on-demand NCD-SSB. The MAC sub-PDU 320-c may be identified by a logical channel ID (LCID), which may be set to a configured value, X, that indicates the MAC-CE 345 is for an on-demand NCD-SSB request. The LCID value for on demand NCD-SSB may be any value configured by the network entity and/or the UE, such as LCID 47, or some other value reserved for NCD-SSB requests. The header for the MAC-CE 345 may include one or more reserved bits, a field length bit that indicates a length of the field, and the LCID. In this example, the field length may be set to a first value (e.g., F=0) that indicates the MAC-CE 345 has a payload of eight bits.

The payload of the MAC-CE 345 may indicate the unique LCID reserved for on-demand NCD-SSB requests and the UE's preference for quantities of instances of the NCD-SSB transmission (e.g., number of subsequent SSB bursts, UE_Num_SSB_Burst_Request). The UE may indicate the quantity of instances via three bits (e.g., three least significant bits) in the payload of the MAC-CE 345. For example, values of “001”, “010”, “011”, “100”, “101” and “111” may correspond to the UE's preference out of a set of defined options (e.g., {n1, n2, n4, n8, n16, n32}). The set of defined options may be indicated via the control signaling that enables the on-demand NCD-SSB requests. A value of “000” may indicate that the UE has no preference for the quantity of SSB bursts. In this example, the network entity may transmit a default quantity of instances of the SSB. The default quantity may be configured via the control signaling (e.g., n-SS-Bursts-NCDSSB). Five other bits in the payload of the MAC-CE 345 may be reserved for other information related to the on-demand NCD-SSB, or any other information.

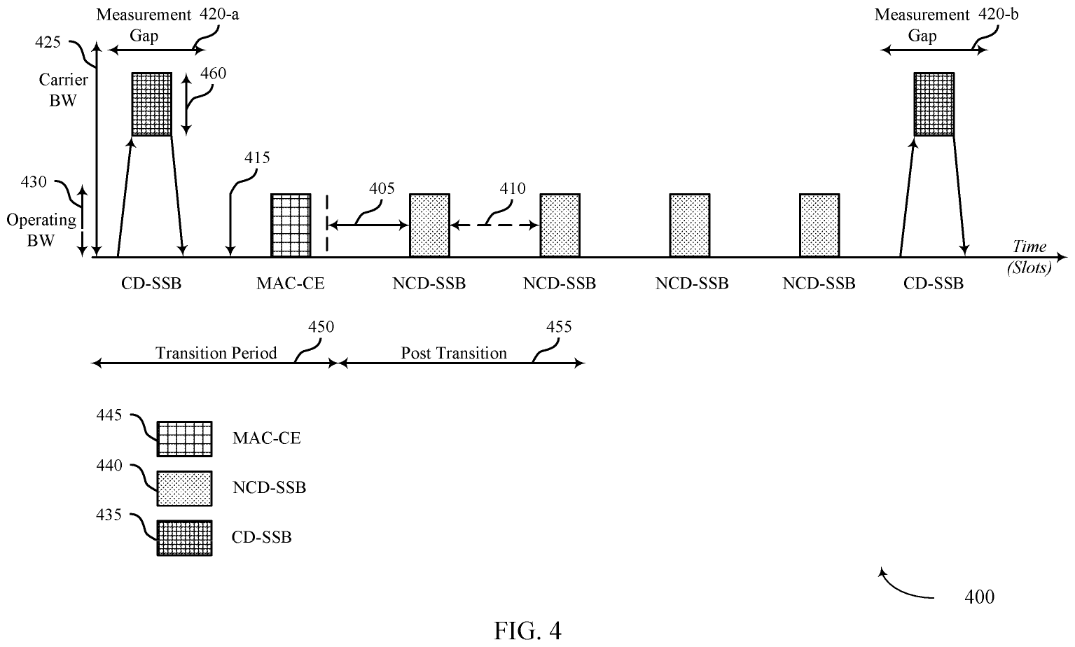

The network entity may receive the MAC-CE 345, decode the MAC-CE 345, and determine that the MAC-CE requests transmission of an NCD-SSB based on the LCID being set to the configured value for on-demand NCD-SSB. The network entity may decode the payload of the MAC-CE 345 to determine whether the UE requested a certain quantity of instances of the NCD-SSB. The network entity may transmit the requested quantity of instances of the NCD-SSB based on the request, as described in further detail elsewhere herein, including with reference to FIG. 4.

FIG. 4 shows an example of a communication timeline 400 that supports on-demand NCD-SSB transmission in accordance with one or more aspects of the present disclosure. The communication timeline 400 may implement or be implemented by aspects of the wireless communications systems 100 and 200, as described with reference to FIGS. 1 and 2. For example, the communication timeline 400 illustrates communications between a network entity and a UE, which may represent examples of corresponding devices as described with reference to FIGS. 1-3. In this example, the network entity may enable on-demand NCD-SSB transmissions, the UE may request for a burst of NCD-SSB instances, and the network entity may transmit the NCD-SSB instances accordingly. When on-demand NCD-SSB is enabled (e.g., configured), the network entity may refrain from transmitting the NCD-SSB until the network entity receives a request for on-demand transmission from the UE.

The UE may support a reduced bandwidth, which may be referred to as an operating bandwidth 430, or an active bandwidth. The operating bandwidth 430 may be a reduced frequency range within a larger carrier bandwidth 425 for the cell. The UE may transition from monitoring the operating bandwidth 430 of the UE to monitoring a frequency external to the operating bandwidth 430 of the UE, but within the carrier bandwidth 425 for a cell, during the measurement gap 420-a. For example, the UE may transition to the frequency 460, which may be within the carrier bandwidth 425 and outside of the operating bandwidth 430 to monitor for a CD-SSB 435. The operating bandwidth 430 and the carrier bandwidth 425 may represent examples of the operating bandwidth 230 and the carrier bandwidth 225 described with reference to FIG. 2. The network entity may transmit a CD-SSB 435 via the frequency 460 during the measurement gap 420-a. The UE may receive and measure the CD-SSB 435 via one or more slots (e.g., two slots, or some other quantity of slots). The UE may transition back to the operating bandwidth 430 at an end of the measurement gap 420-a.

After the measurement gap 420-a, and before a next measurement gap 420, the UE may detect a trigger condition 415. The trigger condition may correspond to a condition at the UE that indicates the UE may benefit from more frequent SSB tracking. For example, the trigger condition 415 may correspond to the UE detecting a timing drift for CD-SSB beams or a change in a suitable beam pair, or some other condition. The UE may transmit a MAC-CE 445 (e.g., a message) that requests for one or more NCD-SSB instances based on the trigger condition 415. The MAC-CE 445 may represent an example of the MAC-CE 245 or the MAC-CE 345 described with reference to FIGS. 2 and 3. For example, the MAC-CE 445 may indicate the request for the NCD-SSB 440 and may indicate a quantity of instances of the NCD-SSB 440.

The UE may transmit the MAC-CE 445 at least a threshold quantity of slots 405 before a first transmission occasion for a first NCD-SSB 440. The threshold quantity of slots 405 may be indicated via control signaling received at the UE, as described with reference to FIG. 2. Additionally, or alternatively, the UE may transmit the MAC-CE 445, and the network entity may determine when to start the NCD-SSB transmission based on a slot in which the MAC-CE 445 is received and the threshold quantity of slots 405. A starting boundary of the first instance of the NCD-SSB 440 may thereby be received at least the threshold quantity of slots 405 after an ending boundary of the MAC-CE 445.

The network entity may transmit the first instance of the NCD-SSB 440 based on the threshold quantity of slots 405 and via the operating bandwidth 430 of the UE. The UE may thereby receive and measure the NCD-SSB 440 within the operating bandwidth 430 without switching frequencies. The network entity may transmit one or more instances of the NCD-SSB 440. A quantity of instances that are transmitted may be based on the quantity requested via the MAC-CE 445. For example, the UE may request a quantity of instances via the MAC-CE 445, or the UE may request a default quantity, and the network entity may select the default quantity of instances accordingly. In the example of FIG. 4, the network entity may transmit four instances of the NCD-SSB 440.

The instances of the NCD-SSB 440 may be transmitted via one or more transmission occasions within the operating bandwidth 430 of the UE. The transmission occasions may be scheduled by the network entity via control signaling that configures the on-demand NCD-SSB transmissions. For example, the control signaling may indicate a frequency, periodicity 410, and/or time offset for the NCD-SSB 440, as described with reference to FIG. 2. The instances of the NCD-SSB 440 may be received in accordance with a periodicity 410, in some aspects. Additionally, or alternatively, the instances may be received at determined times. In some examples, the quantity of instances of the NCD-SSB 440 may be referred to as an NCD-SSB burst.

After the network entity transmits, and the UE receives, the final instance of the requested quantity of instances of the NCD-SSB 440 (e.g., four instances in FIG. 4), the on-demand NCD-SSB transmission may be complete. As such, the network entity may continue to transmit periodic CD-SSBs 435. After receiving the final NCD-SSB 440, the UE may monitor the operating bandwidth 430 until a next measurement gap 420-b that is allocated for SSB measurement. The UE may transition from the operating bandwidth 430 to a frequency (e.g., frequency 460) external to the operating bandwidth 430, but within the carrier bandwidth 425, to monitor for and receive the CD-SSB 435. The UE may thereby continue to periodically measure the CD-SSB 435 via measurement gaps 420 after the NCD-SSB burst. The UE may request another on-demand NCD-SSB transmission later in time if another trigger condition 415 is identified.

The quantity of instances may be requested by the UE via the MAC-CE 445 (e.g., n-SS-Bursts-NCDSSB=n4), or may be a default quantity (e.g., if the UE requests the default via the MAC-CE 445). The default quantity may be a defined quantity. Additionally, or alternatively, in some examples, the default quantity of instances that is configured by the network entity is set to a deactivation default (e.g., nContTxUntilDeact). In such cases, if the MAC-CE 445 transmitted by the UE may indicate that the UE does not have a preference regarding the quantity of instances of the NCD-SSB 440 that are transmitted (e.g., UE_Num_SSB_Burst_Request=000) and the default quantity is set to the deactivation default, the network entity may transmit the NCD-SSB 440 in a semi-persistent manner until the NCD-SSB 440 is deactivated by the network entity. For example, the network entity may transmit the first instance of the NCD-SSB 440 via a first expected location (e.g., a next transmission opportunity that is at least the threshold quantity of slots 405 after the MAC-CE 445) and may transmit remaining instances across subsequent transmission occasions in a semi-persistent manner. The network entity may stop the NCD-SSB 440 after a certain duration. The pattern and duration of the default NCD-SSB transmissions may be determined by the network entity, in some examples. The UE may determine to fall back to tracking the CD-SSB 435 if the UE does not detect the NCD-SSB 440 across a threshold quantity (K) of consecutive transmission occasions (e.g., SSB-Burst locations). The threshold quantity may be a fixed value that is configured for the UE or defined by the UE (e.g., K=6, K=8, or some other quantity). That is, the UE may monitor a quantity of transmission opportunities and, if no NCD-SSB is detected for at least a threshold quantity of transmission opportunities, the UE may fall back to monitoring for the CD-SSB 435 periodically via measurement gaps.

The network entity and the UE may thereby perform on-demand communication of NCD-SSBs within an operating bandwidth 430 for the UE, which may improve reliability of communications, while reducing overhead as compared with systems in which the NCD-SSB 440 is transmitted continuously (e.g., periodically).

The UE may measure the CD-SSB 435 when NCD-SSB 440 is not configured within an evaluation period. The UE may perform radio link management, beam failure detection, Layer 1-reference signal received power (RSRP) measurements, or any combination thereof within the evaluation period. The evaluation period may be based on a combination of a periodicity of the measurement gap 420, a periodicity of the CD-SSBs 435, and a sharing factor (e.g., for sharing the measurement gaps 420). When on-demand NCD-SSB is configured based on the UE's request, the UE evaluation period for radio link management, beam failure detection, RSRP measurements, or the like may be based on a periodicity of the NCD-SSBs 440.

When the UE requests on-demand NCD-SSBs 440, there may be a transition period 450 where the UE may be in the middle of one evaluation period based on the CD-SSB 435, but the UE may have requested activation of an NCD-SSB 440. During this transition period 450, the UE may meet a relaxed requirement for measurement. For example, the UE may meet a first requirement (e.g., a first evaluation period duration) based on a combination of a periodicity of the CD-SSBs 435, a periodicity of the measurement gaps 420, and the sharing factor for one evaluation period, and the UE may meet a second requirement (e.g., a second evaluation period duration) based on a periodicity of the NCD-SSBs 440 for a next evaluation period. That is, during the transition period 450, one evaluation period may be of the first evaluation period duration, and during the post transition period 455, one evaluation period may be of the second evaluation period duration.

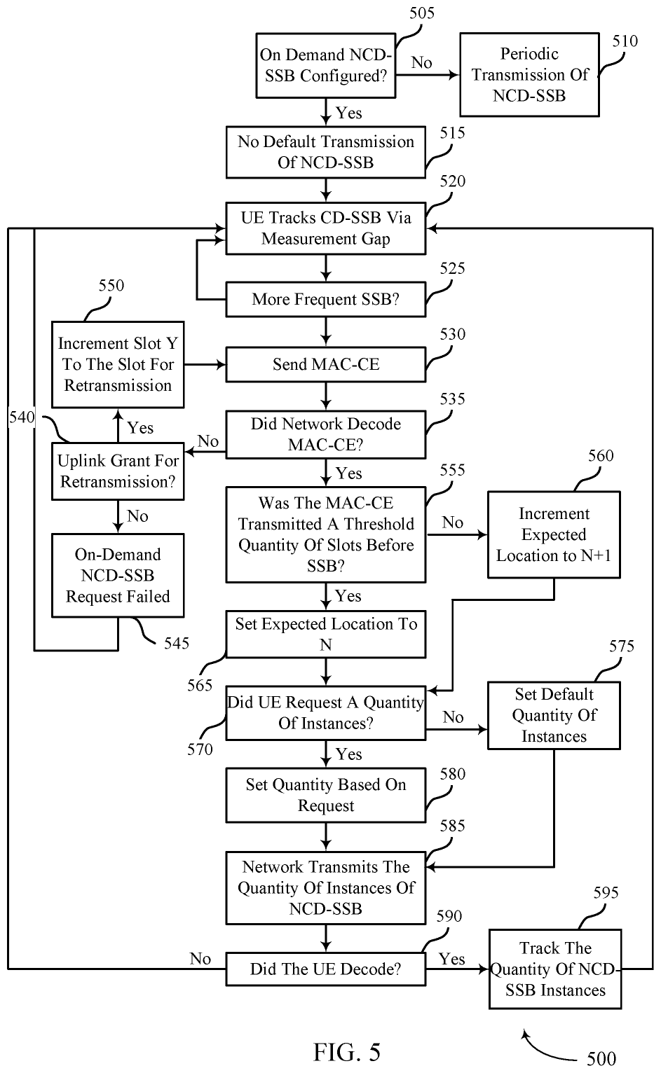

FIG. 5 shows an example of a flow diagram 500 that supports on-demand NCD-SSB transmission in accordance with one or more aspects of the present disclosure. The flow diagram 500 may implement or be implemented by aspects of the wireless communications systems 100 and 200, the MAC-CE configuration 300, or the communication timeline 400, as described with reference to FIGS. 1-4. For example, the flow diagram 500 illustrates an algorithm for on-demand NCD-SSB transmission between a network entity and a UE. The network entity and the UE may represent examples of corresponding devices as described with reference to FIGS. 1-4.

In the following description of the flow diagram 500, the operations may be performed in different orders or at different times. Some operations may also be left out of the flow diagram 500, or other operations may be added. The flow diagram 500 illustrates various decisions and operations performed by the network entity, the UE, one or more other wireless devices or components in the wireless communications system, or any combination thereof. Although the operations illustrated in FIG. 5 are described as being performed by the network entity and/or the UE, it is to be understood that the operations may be performed by any device to facilitate on-demand transmission of NCD-SSBs from a network to a UE.

At 505, the network entity and the UE may determine whether on-demand NCD-SSB is configured. For example, the network entity and the UE may determine whether the NCD-SSB is configured in an active BWP of a UE, and whether the on-demand NCD-SSB requests have been enabled (e.g., RequestOnDemand=setup && OnDemand-NonCellDefiningSSB=True?). If the NCD-SSB is not configured, the network entity may not transmit the NCD-SSB. If the NCD-SSB is configured, but the on-demand NCD-SSB is not enabled, at 510, the network entity may perform periodic NCD-SSB transmissions. For example, the network entity may transmit the NCD-SSB periodically via one or more transmission occasions within an active BWP of the UE based on the NCD-SSB configuration. The UE may monitor for and receive the NCD-SSBs accordingly.

At 515, if the on-demand NCD-SSB is enabled, the network entity may refrain from transmitting the NCD-SSB periodically. That is, the network entity may default to not transmitting the NCD-SSB in the active BWP of the UE, and may instead transmit the NCD-SSB on-demand. The UE may determine whether to monitor for the NCD-SSB based on whether the on-demand NCD-SSB is enabled (e.g., based on control signaling received at the UE).

At 520, the UE may track the CD-SSB via one or more measurement gaps. The network entity may periodically transmit the CD-SSB via a frequency that is external to the active BWP of the UE, but within a carrier bandwidth. The UE may track and measure the CD-SSB based on the on-demand NCD-SSB being enabled. At 525, the UE may determine whether more frequent SSB measurements would be beneficial. The UE may make the determination based on one or more conditions, as described with reference to FIGS. 2-4. If more frequent SSB measurements are not beneficial, the UE may continue to track the CD-SSB via the measurement gaps.

At 530, if the UE determines that more frequent SSB tracking would be beneficial, the UE may transmit a MAC-CE to the network entity. The MAC-CE may indicate a request for the network entity to transmit one or more NCD-SSBs. The MAC-CE may indicate the request and a quantity of instances of the NCD-SSB, as described with reference to FIGS. 3 and 4. A slot at which the UE transmits the physical uplink shared channel (PUSCH) containing the uplink MAC-CE (e.g., with the LCID that indicates a request for on-demand NCD-SSB) may be referred to as slot Y. At 535, it may be determined whether the network entity successfully decoded the MAC-CE.

At 540, if the network entity did not successfully decode the MAC-CE, the network entity may, in some examples, determine whether to transmit an uplink grant to the UE to request a retransmission of the MAC-CE. At 545, if the network entity does not transmit the uplink grant, the UE may refrain from retransmitting the MAC-CE, and the UE may continue to track the CD-SSB via the measurement gap at 520. In some examples, the UE may receive a NACK or some other indication that the network entity did not decode the MAC-CE. Additionally, or alternatively, the UE may determine that no NCD-SSBs are sent in response to the MAC-CE, and the UE may return to monitoring the CD-SSB after some threshold time period in which the UE does not detect the NCD-SSB.

At 550, if the network entity transmits an uplink grant and requests retransmission of the MAC-CE, the network entity may increment the slot Y to the slot scheduled for the MAC-CE retransmission. At 530, the UE may retransmit the MAC-CE via the slot Y indicated via the uplink grant.

At 555, if the network entity successfully decodes the MAC-CE (e.g., the first transmission or a retransmission), the network entity and the UE may determine whether the MAC-CE was transmitted a threshold quantity of slots before a slot, X, that is allocated for the NCD-SSB transmission (e.g., a slot of an NCD-SSB instance having an index of zero within a burst of NCD-SSBs). One or more transmission occasions (e.g., slots) may be scheduled for an NCD-SSB burst of index N. The network entity and the UE may determine the transmission occasions (e.g., frame locations) based on a periodicity of the SSB, an offset of the SSB, or both configured via the NCD-SSB configuration. The slot X may be a first slot within a most recent burst, N, after the MAC-CE. The threshold quantity of slots may represent an example of the threshold quantity of slots 405 described with reference to FIG. 4. The network entity and the UE may determine (e.g., set, store) an expected location (slot) via which the NCD-SSB may be transmitted based on the threshold quantity.

For example, at 560, if the MAC-CE is not transmitted at least the threshold quantity of slots before the next transmission occasion (e.g., X-Y<nSlotsAdvance, where nSlotsAdvance is the threshold quantity of slots), the network entity and the UE may increment the index of the expected NCD-SSB burst to N+1. At 565, if the MAC-CE is transmitted at least the threshold quantity of slots before the next transmission occasion (e.g., X-Y≥nSlotsAdvance, where nSlotsAdvance is the threshold quantity of slots), the network entity and the UE may set the index for the expected NCD-SSB burst to N (e.g., a first set of transmission occasions). In this way, the network entity and the UE may determine which transmission occasion may be used for the NCD-SSB.

At 570, the network entity may determine whether the UE requested a quantity of instances. That is, the network entity may determine, based on an indication in the MAC-CE, whether the UE requested a quantity of instances of the NCD-SSB or indicated a request for the network entity to select the quantity of instances (e.g., a default quantity). At 575, if the UE did not explicitly request a quantity of instances, the network entity may set a default quantity of instances. The default quantity may be configured or indicated via the NCD-SSB configuration, in some examples, as described with reference to FIGS. 2 and 3. At 580, if the UE did request a certain quantity of instances, the network entity may set the quantity equal to the quantity indicated via the request.

At 585, the network entity may transmit the quantity of instances of the NCD-SSB. The network entity may transmit a first instance of the NCD-SSB to the UE via the slot X within the expected burst Nor N+1, as determined at 560 and 565. If the quantity of instances is more than one, the network entity may transmit the remaining instances of the NCD-SSB via subsequent slots in accordance with an NCD-SSB periodicity and time offset configured by the network entity, as described with reference to FIG. 4. The UE may monitor for and receive the quantity of instances of the NCD-SSB.

At 590, it may be determined whether the UE successfully decoded the quantity of NCD-SSB instances. In some examples, the UE may make the determination internally, or the UE may transmit an acknowledgment or a negative acknowledgment to indicate that the UE did or did not decode the NCD-SSB, respectively. If the UE is not able to decode the NCD-SSB, the UE may return to 520 to track the CD-SSB during the measurement gaps. At 595, if the UE is able to successfully decode the NCD-SSB, the UE may track the quantity of NCD-SSB instances. The UE may continue to monitor the indicated NCD-SSB frequency for at least the quantity of instances in accordance with the NCD-SSB periodicity. After the UE tracks the quantity of NCD-SSB instances, the UE may return to tracking, at 520, the CD-SSB via measurement gaps.

The network entity may thereby configure and facilitate on-demand NCD-SSB transmissions. When the on-demand NCD-SSB is configured, the UE may request, dynamically, for NCD-SSBs to be transmitted when the UE needs more frequent SSB measurements, and the UE may monitor a CD-SSB in an external frequency when the UE does not need more frequent SSB measurements. The network entity and the UE may thereby support improved throughput and reliability while reducing overhead.

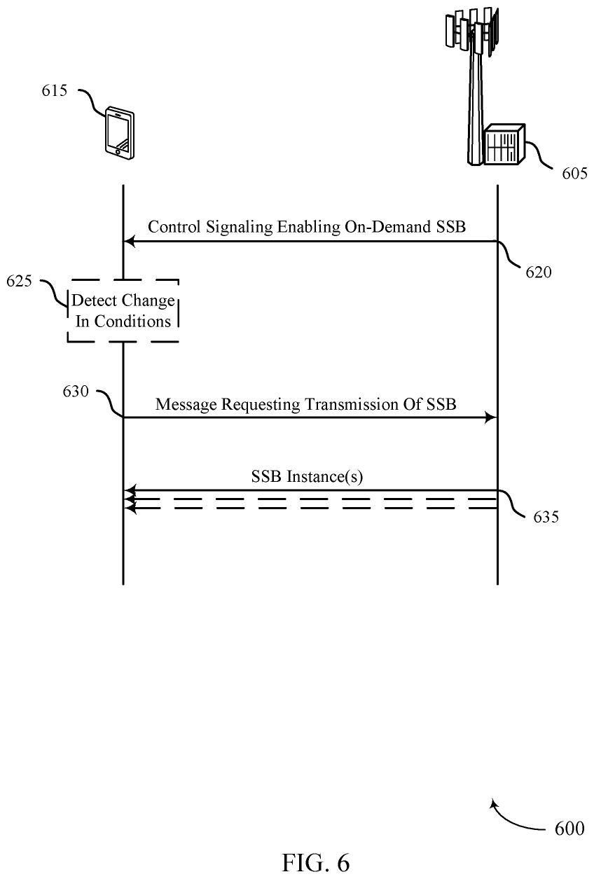

FIG. 6 shows an example of a process flow 600 that supports on-demand NCD-SSB transmission in accordance with one or more aspects of the present disclosure. The process flow 600 may implement or be implemented by aspects of the wireless communications systems 100 and 200, the MAC-CE configuration 300, the communication timeline 400, or the flow diagram 500, as described with reference to FIGS. 1-5. For example, the process flow 600 illustrates communications between a network entity 605 and a UE 615, which may represent examples of corresponding devices as described with reference to FIGS. 1-5.

In the following description of the process flow 600, the operations may be performed in different orders or at different times. Some operations may also be left out of the process flow 600, or other operations may be added. Although network entity 605 and the UE 615 are shown performing the operations of the process flow 600, some aspects of some operations may also be performed by one or more other wireless devices.

At 620, the network entity 605 may transmit, to the UE 615, control signaling that enables on-demand transmission of a first SSB for a cell. The control signaling may enable the first SSB for transmission via one or more transmission opportunities of an operating bandwidth of the UE 615. For example, the control signaling (e.g., an RRC message, or some other type of signaling) may configure an SSB periodicity, time offset, frequency, or any combination thereof, as described with reference to FIG. 2. The SSB may represent an example of an NCD-SSB, in some examples herein. The control signaling may represent an example of the control signaling 250 as described in further detail with reference to FIG. 2. In some examples, the UE 615 may transmit a capability message that indicates a capability of the UE 615 to support on-demand SSB communications, and the network entity 605 may transmit the control signaling in response to or based on the UE capability message. The network entity 605 may refrain from periodically or semi-statically transmitting the first SSB until the network entity 605 receives a request for on-demand transmission based on the control signaling.

The UE 615 may monitor, periodically, for a second SSB within a second frequency in a carrier bandwidth for the cell. The second SSB may be associated with system information for the cell. For example, the second SSB may be associated with a CORESET0, a SIB-1, or some other type of system information. The second SSB may be, for example, a CD-SSB as described herein. The second frequency may be external to the operating frequency of the UE.

In some examples, at 625, the UE 615 may detect a change in one or more conditions associated with the UE 615, the second SSB, or both. For example, the UE 615 may detect a timing drift of beams associated with the second SSB, or a change in a beam pair link, or both. The change in the one or more conditions may indicate that more frequent measurements may be beneficial for communications (e.g., more frequent than a CD-SSB).

At 630, the UE 615 may transmit, to the network entity 605, a message that requests transmission of one or more instances of the first SSB. The UE 615 may transmit the message based on the control signaling, the change detected at 625, or both. The message may be a MAC-CE, or some other type of message. An ID of the message may indicate the request for the transmission of the first SSB. In some examples, the message may include an indication of a quantity of instances of the first SSB that the UE 615 is requesting.

At 635, the network entity 605 may transmit, to the UE 615 based on the message, the one or more instances of the first SSB. The first SSB may be transmitted within the operating bandwidth of the UE 615 and via at least one of the transmission opportunities configured via the control signaling. The timing of the first SSB instances may be determined in accordance with an algorithm, as described in further detail elsewhere herein, including with reference to FIG. 5. If the message indicates a quantity of instances, the network entity 605 may transmit the requested quantity of instances or a quantity that is based in part on the requested quantity. If the message indicates the UE 615 does not have a preference regarding the quantity, the network entity 605 may transmit a default quantity of instances of the first SSB. The default quantity may be indicated via the control signaling.

The UE 615 may monitor for and receive the one or more instances of the first SSB within the operating bandwidth of the UE 615. After the one or more instances are received, the UE 615 may continue to periodically transmit to a second frequency to monitor for a second SSB.

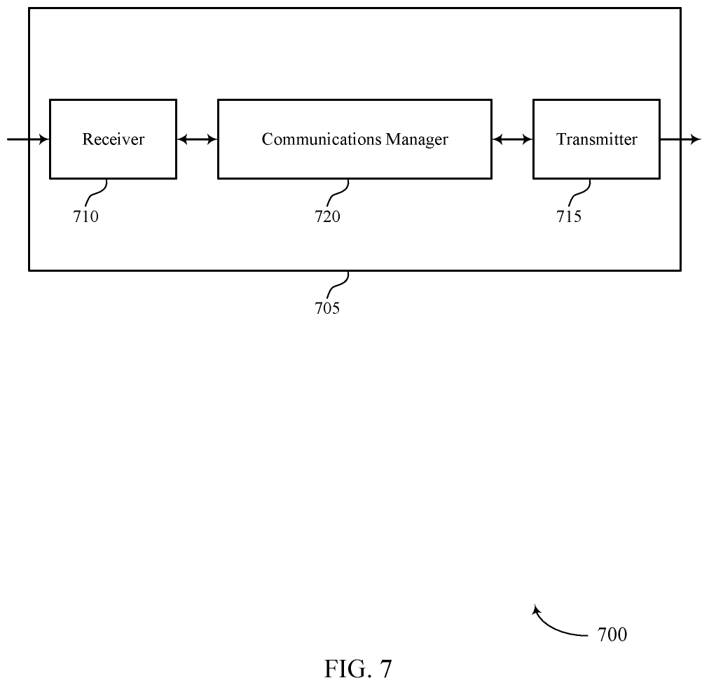

FIG. 7 shows a block diagram 700 of a device 705 that supports on-demand NCD SSB transmission in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to on-demand NCD SSB transmission). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to on-demand NCD SSB transmission). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of on-demand NCD SSB transmission as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

Additionally, or alternatively, the communications manager 720 may support wireless communication in accordance with examples as disclosed herein. For example, the communications manager 720 is capable of, configured to, or operable to support a means for receiving control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE. The communications manager 720 is capable of, configured to, or operable to support a means for transmitting, in accordance with the on-demand transmission scheme, a message requesting transmission of one or more instances of the first SSB. The communications manager 720 is capable of, configured to, or operable to support a means for receiving, based on the message, the one or more instances of the first SSB in the operating bandwidth of the UE via at least one transmission opportunity of the set of multiple transmission opportunities.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources, among other examples.

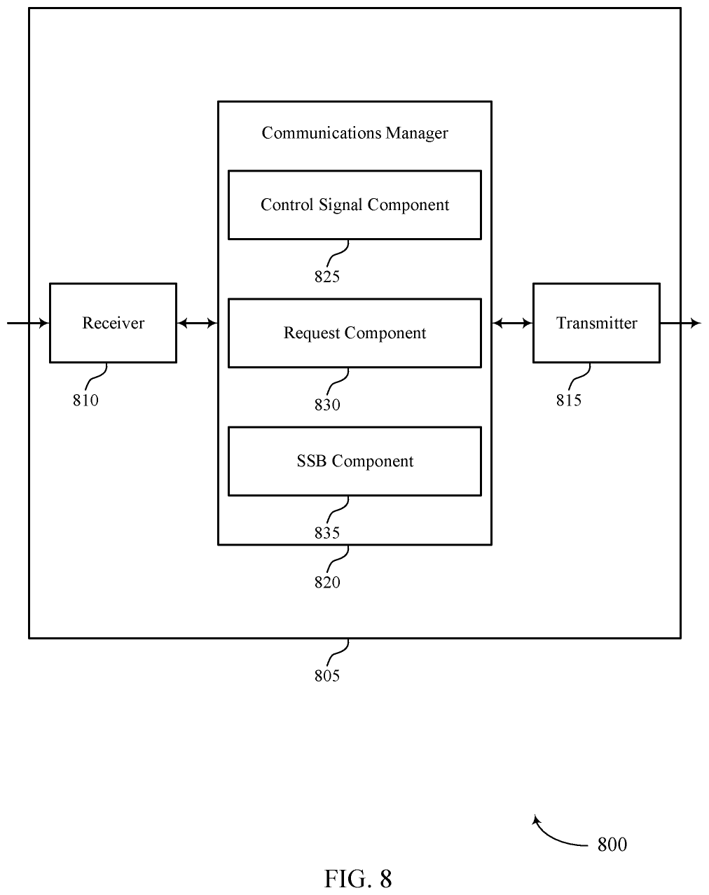

FIG. 8 shows a block diagram 800 of a device 805 that supports on-demand NCD SSB transmission in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to on-demand NCD SSB transmission). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to on-demand NCD SSB transmission). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of on-demand NCD SSB transmission as described herein. For example, the communications manager 820 may include a control signal component 825, a request component 830, an SSB component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The control signal component 825 is capable of, configured to, or operable to support a means for receiving control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE. The request component 830 is capable of, configured to, or operable to support a means for transmitting, in accordance with the on-demand transmission scheme, a message requesting transmission of one or more instances of the first SSB. The SSB component 835 is capable of, configured to, or operable to support a means for receiving, based on the message, the one or more instances of the first SSB in the operating bandwidth of the UE via at least one transmission opportunity of the set of multiple transmission opportunities.

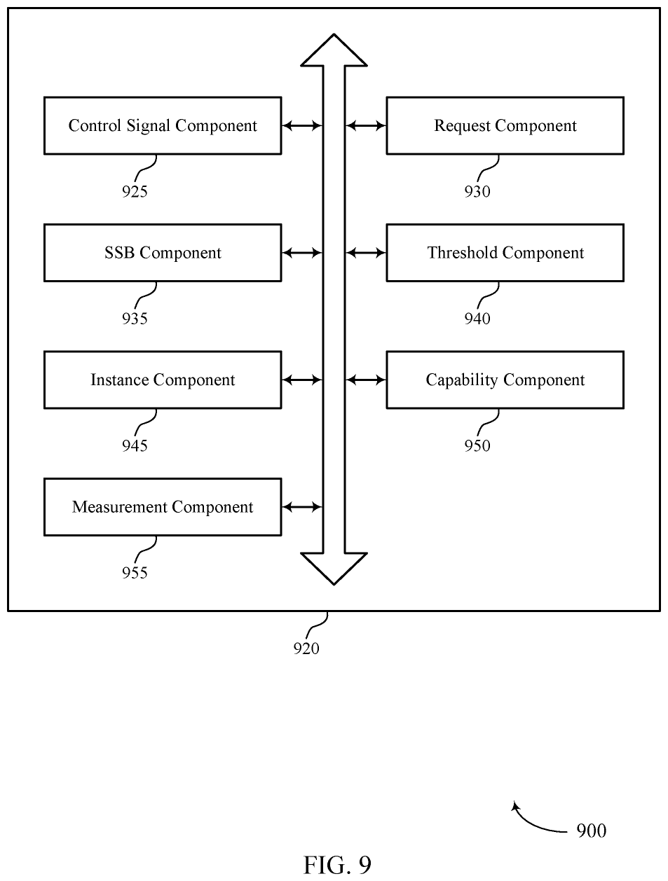

FIG. 9 shows a block diagram 900 of a communications manager 920 that supports on-demand NCD SSB transmission in accordance with one or more aspects of the present disclosure. The communications manager 920 may be an example of aspects of a communications manager 720, a communications manager 820, or both, as described herein. The communications manager 920, or various components thereof, may be an example of means for performing various aspects of on-demand NCD SSB transmission as described herein. For example, the communications manager 920 may include a control signal component 925, a request component 930, an SSB component 935, a threshold component 940, an instance component 945, a capability component 950, a measurement component 955, or any combination thereof. Each of these components, or components or subcomponents thereof (e.g., one or more processors, one or more memories), may communicate, directly or indirectly, with one another (e.g., via one or more buses).

Additionally, or alternatively, the communications manager 920 may support wireless communication in accordance with examples as disclosed herein. The control signal component 925 is capable of, configured to, or operable to support a means for receiving control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE. The request component 930 is capable of, configured to, or operable to support a means for transmitting, in accordance with the on-demand transmission scheme, a message requesting transmission of one or more instances of the first SSB. The SSB component 935 is capable of, configured to, or operable to support a means for receiving, based on the message, the one or more instances of the first SSB in the operating bandwidth of the UE via at least one transmission opportunity of the set of multiple transmission opportunities.

In some examples, to support receiving the control signaling, the threshold component 940 is capable of, configured to, or operable to support a means for receiving, via the control signaling, an indication of a quantity of slots between the message and a first instance of the one or more instances of the first SSB, where the first instance is received at least the quantity of slots after the message is transmitted.

In some examples, to support transmitting the message, the instance component 945 is capable of, configured to, or operable to support a means for transmitting, via the message, an indication of a quantity of instances requested by the UE, where the one or more instances of the first SSB include the quantity of instances based on the message.

In some examples, to support transmitting the message, the instance component 945 is capable of, configured to, or operable to support a means for transmitting, via the message, a selection request that requests for a network entity to select a default quantity of the one or more instances, where the one or more instances include the default quantity of instances based on the selection request.

In some examples, to support receiving the control signaling, the instance component 945 is capable of, configured to, or operable to support a means for receiving, via the control signaling, an indication of the default quantity of instances of the first SSB.

In some examples, to support receiving the one or more instances of the first SSB, the instance component 945 is capable of, configured to, or operable to support a means for receiving, via a first set of transmission opportunities from the set of multiple transmission opportunities, a set of multiple instances of the first SSB based on the default quantity of instances being associated with a semi-persistent transmission pattern. In some examples, to support receiving the one or more instances of the first SSB, the instance component 945 is capable of, configured to, or operable to support a means for monitoring a second set of one or more transmission opportunities of the set of multiple transmission opportunities. In some examples, to support receiving the one or more instances of the first SSB, the instance component 945 is capable of, configured to, or operable to support a means for transitioning, after monitoring a threshold quantity of the second set of one or more transmission opportunities that exclude the first SSB, to periodically monitoring a second frequency in the carrier bandwidth for a second SSB that is associated with system information of the cell, the second frequency external to the operating bandwidth of the UE.

In some examples, the capability component 950 is capable of, configured to, or operable to support a means for transmitting a capability message that indicates a capability of the UE to support on-demand SSB communications, where receiving the control signaling is based on the capability message.

In some examples, the SSB component 935 is capable of, configured to, or operable to support a means for periodically monitoring a second frequency in the carrier bandwidth for a second SSB that is associated with system information of the cell, the second frequency external to the operating bandwidth of the UE, where transmitting the message is based on a change in one or more conditions associated with the second SSB. In some examples, the change in the one or more conditions includes a timing drift of beams associated with the second SSB, or a change in a beam pair link, or both.

In some examples, the measurement component 955 is capable of, configured to, or operable to support a means for evaluating one or more communication metrics during a first time period based on monitoring the second frequency for the second SSB. In some examples, the measurement component 955 is capable of, configured to, or operable to support a means for evaluating the one or more communication metrics during a second time period based on receiving the one or more instances of the first SSB, where the second time period is longer than the first time period.

In some examples, the SSB component 935 is capable of, configured to, or operable to support a means for periodically monitoring, after receiving the one or more instances of the first SSB, a second frequency in the carrier bandwidth for a second SSB that is associated with system information of the cell, the second frequency external to the operating bandwidth of the UE.

In some examples, to support receiving the control signaling, the SSB component 935 is capable of, configured to, or operable to support a means for receiving, via the control signaling, an indication of a frequency associated with the first SSB, a periodicity associated with the first SSB, a time offset associated with the first SSB, or any combination thereof, where the frequency is within the operating bandwidth of the UE.

In some examples, an LCID of the message indicates a request for transmission of the one or more instances of the first SSB. In some examples, the control signaling includes RRC signaling and the message includes a MAC-CE. In some examples, the first SSB is different from a second SSB that is associated with system information of the cell, the first SSB including a non-cell defining SSB and the second SSB including a cell defining SSB.

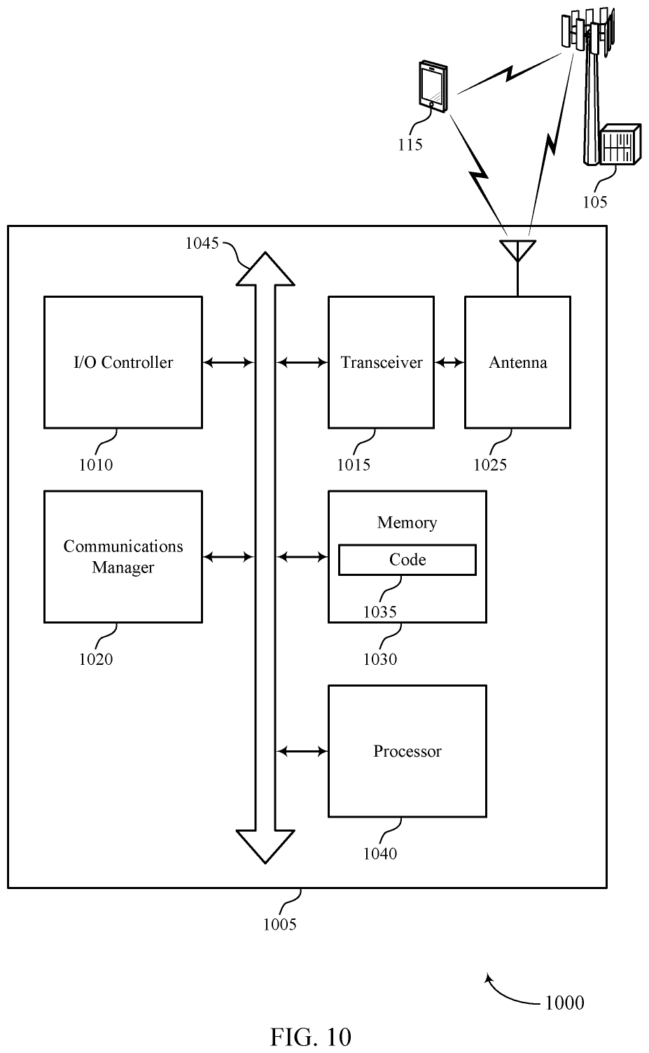

FIG. 10 shows a diagram of a system 1000 including a device 1005 that supports on-demand NCD SSB transmission in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting on-demand NCD SSB transmission). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. As such, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

Additionally, or alternatively, the communications manager 1020 may support wireless communication in accordance with examples as disclosed herein. For example, the communications manager 1020 is capable of, configured to, or operable to support a means for receiving control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE. The communications manager 1020 is capable of, configured to, or operable to support a means for transmitting, in accordance with the on-demand transmission scheme, a message requesting transmission of one or more instances of the first SSB. The communications manager 1020 is capable of, configured to, or operable to support a means for receiving, based on the message, the one or more instances of the first SSB in the operating bandwidth of the UE via at least one transmission opportunity of the set of multiple transmission opportunities.

By including or configuring the communications manager 1020 in accordance with examples as described herein, the device 1005 may support techniques for improved communication reliability, reduced latency, reduced power consumption, more efficient utilization of communication resources, improved coordination between devices, and improved utilization of processing capability, among other examples.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of on-demand NCD SSB transmission as described herein, or the at least one processor 1040 and the at least one memory 1030 may be otherwise configured to, individually or collectively, perform or support such operations.

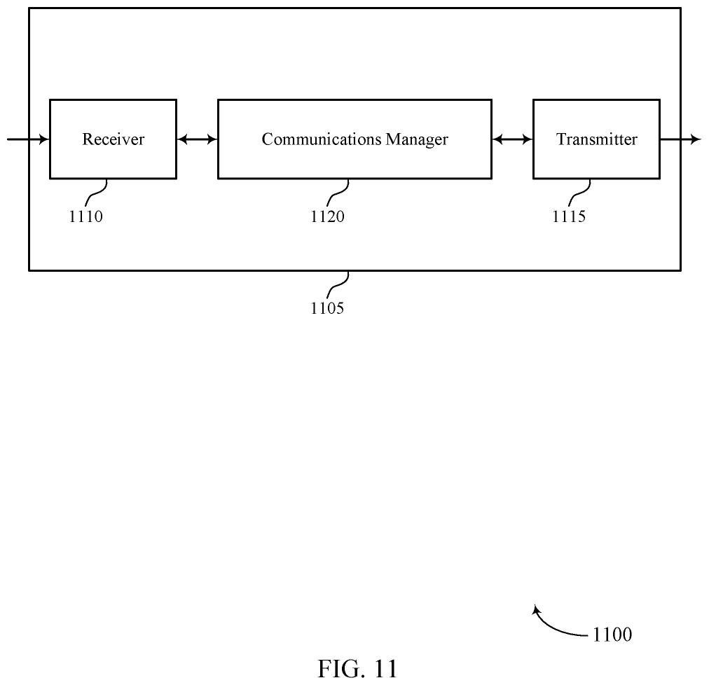

FIG. 11 shows a block diagram 1100 of a device 1105 that supports on-demand NCD SSB transmission in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of on-demand NCD SSB transmission as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

Additionally, or alternatively, the communications manager 1120 may support wireless communication in accordance with examples as disclosed herein. For example, the communications manager 1120 is capable of, configured to, or operable to support a means for transmitting control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE. The communications manager 1120 is capable of, configured to, or operable to support a means for receiving, in accordance with the on-demand transmission scheme, a message requesting transmission of one or more instances of the first SSB. The communications manager 1120 is capable of, configured to, or operable to support a means for transmitting, based on the message, the one or more instances of the first SSB in the operating bandwidth of the UE via at least one transmission opportunity of the set of multiple transmission opportunities.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources, among other examples.

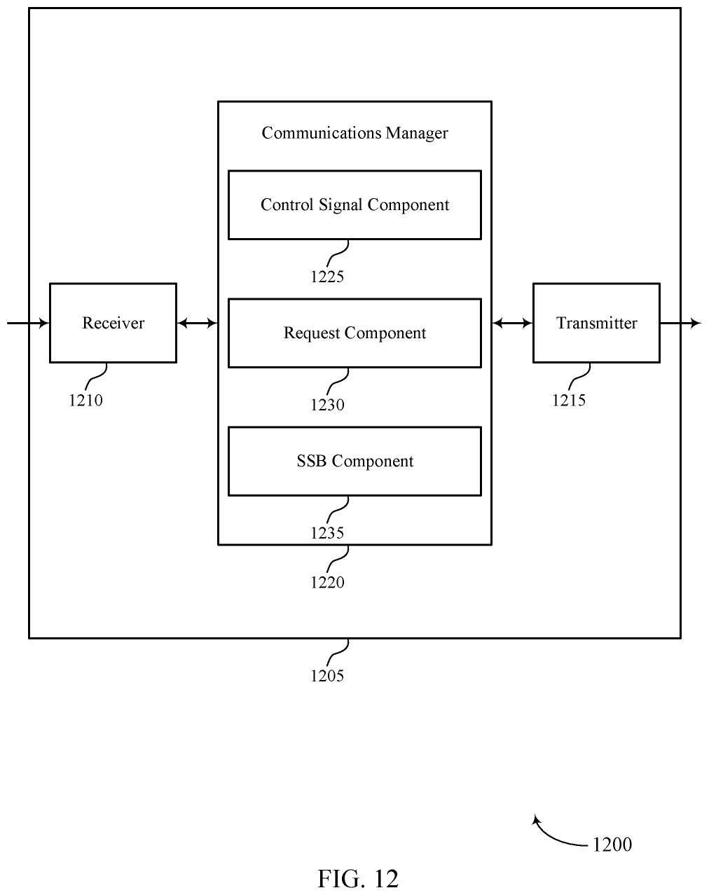

FIG. 12 shows a block diagram 1200 of a device 1205 that supports on-demand NCD SSB transmission in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of on-demand NCD SSB transmission as described herein. For example, the communications manager 1220 may include a control signal component 1225, a request component 1230, an SSB component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The control signal component 1225 is capable of, configured to, or operable to support a means for transmitting control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE. The request component 1230 is capable of, configured to, or operable to support a means for receiving, in accordance with the on-demand transmission scheme, a message requesting transmission of one or more instances of the first SSB. The SSB component 1235 is capable of, configured to, or operable to support a means for transmitting, based on the message, the one or more instances of the first SSB in the operating bandwidth of the UE via at least one transmission opportunity of the set of multiple transmission opportunities.

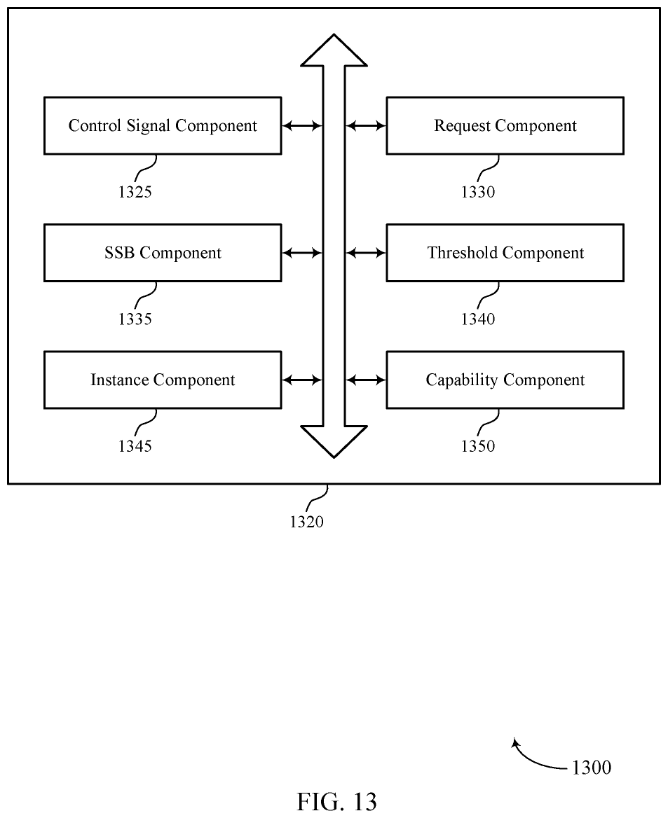

FIG. 13 shows a block diagram 1300 of a communications manager 1320 that supports on-demand NCD SSB transmission in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of on-demand NCD SSB transmission as described herein. For example, the communications manager 1320 may include a control signal component 1325, a request component 1330, an SSB component 1335, a threshold component 1340, an instance component 1345, a capability component 1350, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1320 may support wireless communication in accordance with examples as disclosed herein. The control signal component 1325 is capable of, configured to, or operable to support a means for transmitting control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE. The request component 1330 is capable of, configured to, or operable to support a means for receiving, based on the control signaling, a message requesting transmission of one or more instances of the first SSB. The SSB component 1335 is capable of, configured to, or operable to support a means for transmitting, based on the message, the one or more instances of the first SSB in the operating bandwidth of the UE via at least one transmission opportunity of the set of multiple transmission opportunities.

In some examples, to support transmitting the control signaling, the threshold component 1340 is capable of, configured to, or operable to support a means for transmitting, via the control signaling, an indication of a threshold quantity of slots between the message and a first instance of the one or more instances of the first SSB, where the first instance is transmitted at least the threshold quantity of slots after the message is received.

In some examples, to support receiving the message, the instance component 1345 is capable of, configured to, or operable to support a means for receiving, via the message, an indication of a quantity of instances requested by the UE, where the one or more instances of the first SSB include the quantity of instances based on the message.

In some examples, to support receiving the message, the instance component 1345 is capable of, configured to, or operable to support a means for receiving, via the message, a selection request that requests for the network entity to select a default quantity of the one or more instances, where the one or more instances include the default quantity of instances based on the selection request.

In some examples, to support transmitting the control signaling, the instance component 1345 is capable of, configured to, or operable to support a means for transmitting, via the control signaling, an indication of the default quantity of instances of the first SSB.

In some examples, to support transmitting the one or more instances of the first SSB, the instance component 1345 is capable of, configured to, or operable to support a means for transmitting, via a first set of transmission opportunities from the set of multiple transmission opportunities, a set of multiple instances of the first SSB based on the default quantity of instances being associated with a semi-persistent transmission pattern, where the control signaling indicates that the default quantity of instances is associated with the semi-persistent transmission pattern.

In some examples, the capability component 1350 is capable of, configured to, or operable to support a means for receiving a capability message that indicates a capability of the UE to support on-demand SSB communications, where transmitting the control signaling is based on the capability message.

In some examples, the SSB component 1335 is capable of, configured to, or operable to support a means for periodically transmitting, via a second frequency in the carrier bandwidth, a second SSB that is associated with system information of the cell, the second frequency external to the operating bandwidth of the UE.

In some examples, the SSB component 1335 is capable of, configured to, or operable to support a means for periodically transmitting, after transmitting the one or more instances of the first SSB and via a second frequency in the carrier bandwidth, a second SSB that is associated with system information of the cell, the second frequency external to the operating bandwidth of the UE.

In some examples, to support transmitting the control signaling, the SSB component 1335 is capable of, configured to, or operable to support a means for transmitting, via the control signaling, an indication of a frequency associated with the first SSB, a periodicity associated with the first SSB, a time offset associated with the first SSB, or any combination thereof, where the frequency is within the operating bandwidth of the UE.

In some examples, the SSB component 1335 is capable of, configured to, or operable to refrain from transmitting the first SSB before receiving the message based on the control signaling configuring the on-demand transmission scheme for the first SSB.

In some examples, an LCID of the message indicates a request for transmission of the one or more instances of the first SSB. In some examples, the control signaling includes RRC signaling and the message includes a MAC-CE. In some examples, the first SSB is different from a second SSB that is associated with system information of the cell, the first SSB including a non-cell defining SSB and the second SSB including a cell defining SSB.

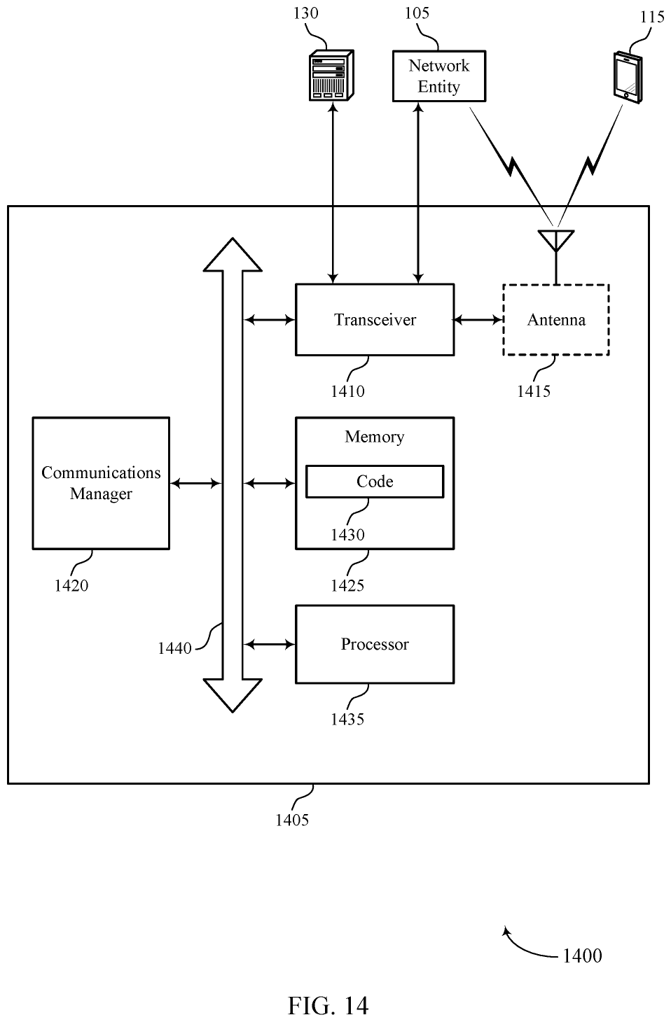

FIG. 14 shows a diagram of a system 1400 including a device 1405 that supports on-demand NCD SSB transmission in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting on-demand NCD SSB transmission). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. As such, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

Additionally, or alternatively, the communications manager 1420 may support wireless communication in accordance with examples as disclosed herein. For example, the communications manager 1420 is capable of, configured to, or operable to support a means for transmitting control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE. The communications manager 1420 is capable of, configured to, or operable to support a means for receiving, based on the control signaling, a message requesting transmission of one or more instances of the first SSB. The communications manager 1420 is capable of, configured to, or operable to support a means for transmitting, based on the message, the one or more instances of the first SSB in the operating bandwidth of the UE via at least one transmission opportunity of the set of multiple transmission opportunities.

By including or configuring the communications manager 1420 in accordance with examples as described herein, the device 1405 may support techniques for improved communication reliability, reduced latency, reduced power consumption, more efficient utilization of communication resources, improved coordination between devices, and improved utilization of processing capability, among other examples.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of on-demand NCD SSB transmission as described herein, or the at least one processor 1435 and the at least one memory 1425 may be otherwise configured to, individually or collectively, perform or support such operations.

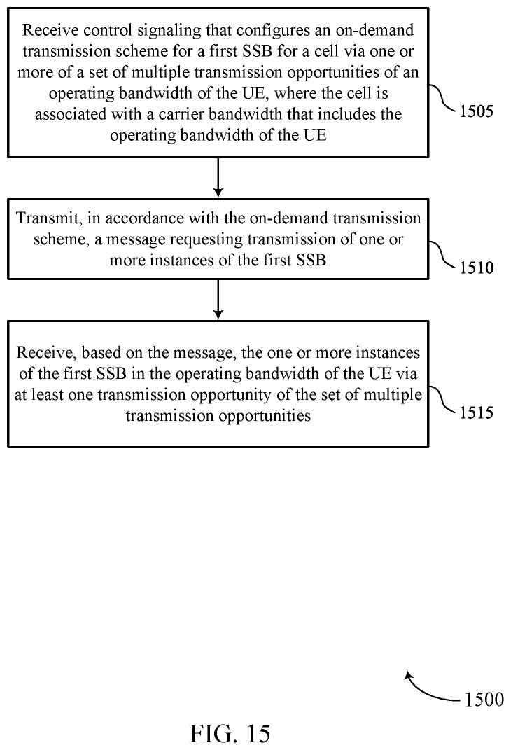

FIG. 15 shows a flowchart illustrating a method 1500 that supports on-demand NCD SSB transmission in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE. The operations of block 1505 may be performed in accordance with examples as disclosed herein. In some examples, aspects of the operations of 1505 may be performed by a control signal component 925 as described with reference to FIG. 9.

At 1510, the method may include transmitting, in accordance with the on-demand transmission scheme, a message requesting transmission of one or more instances of the first SSB. The operations of block 1510 may be performed in accordance with examples as disclosed herein. In some examples, aspects of the operations of 1510 may be performed by a request component 930 as described with reference to FIG. 9.

At 1515, the method may include receiving, based on the message, the one or more instances of the first SSB in the operating bandwidth of the UE via at least one transmission opportunity of the set of multiple transmission opportunities. The operations of block 1515 may be performed in accordance with examples as disclosed herein. In some examples, aspects of the operations of 1515 may be performed by an SSB component 935 as described with reference to FIG. 9.

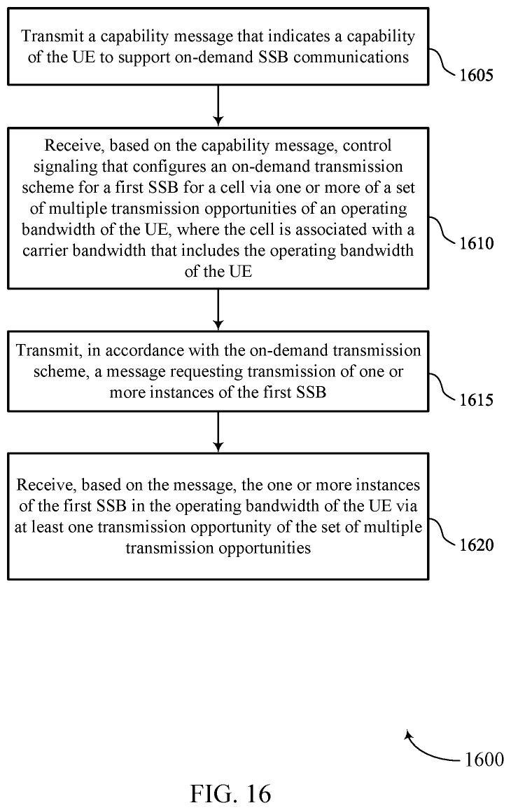

FIG. 16 shows a flowchart illustrating a method 1600 that supports on-demand NCD SSB transmission in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting a capability message that indicates a capability of the UE to support on-demand SSB communications. The operations of block 1605 may be performed in accordance with examples as disclosed herein. In some examples, aspects of the operations of 1605 may be performed by a capability component 950 as described with reference to FIG. 9.

At 1610, the method may include receiving, based on the capability message, control signaling that configures an on-demand transmission scheme for a first SSB for a cell via one or more of a set of multiple transmission opportunities of an operating bandwidth of the UE, where the cell is associated with a carrier bandwidth that includes the operating bandwidth of the UE. The operations of block 1610 may be performed in accordance with examples as disclosed herein. In some examples, aspects of the operations of 1610 may be performed by a control signal component 925 as described with reference to FIG. 9.

At 1615, the method may include transmitting, in accordance with the on-demand transmission scheme, a message requesting transmission of one or more instances of the first SSB. The operations of block 1615 may be performed in accordance with examples as disclosed herein. In some examples, aspects of the operations of 1615 may be performed by a request component 930 as described with reference to FIG. 9.

At 1620, the method may include receiving, based on the message, the one or more instances of the first SSB in the operating bandwidth of the UE via at least one transmission opportunity of the set of multiple transmission opportunities. The operations of block 1620 may be performed in accordance with examples as disclosed herein. In some examples, aspects of the operations of 1620 may be performed by an SSB component 935 as described with reference to FIG. 9.

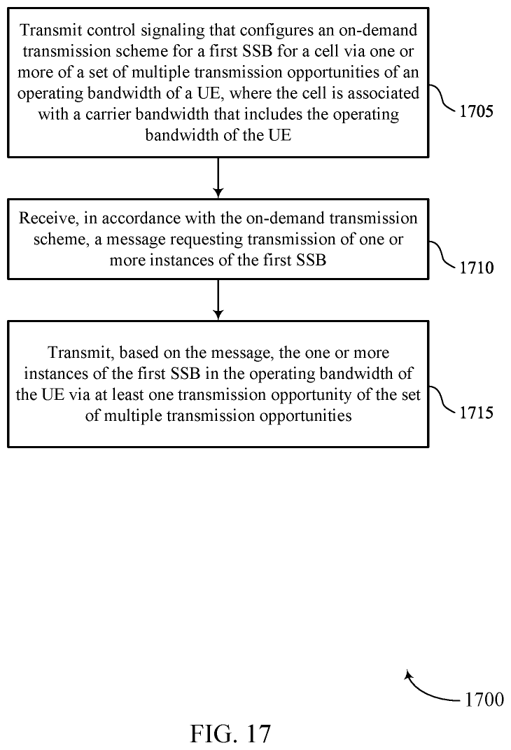

FIG. 17 shows a flowchart illustrating a method 1700 that supports on-demand NCD SSB transmission in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE. The operations of block 1705 may be performed in accordance with examples as disclosed herein. In some examples, aspects of the operations of 1705 may be performed by a control signal component 1325 as described with reference to FIG. 13.

At 1710, the method may include receiving, in accordance with the on-demand transmission scheme, a message requesting transmission of one or more instances of the first SSB. The operations of block 1710 may be performed in accordance with examples as disclosed herein. In some examples, aspects of the operations of 1710 may be performed by a request component 1330 as described with reference to FIG. 13.

At 1715, the method may include transmitting, based on the message, the one or more instances of the first SSB in the operating bandwidth of the UE via at least one transmission opportunity of the set of multiple transmission opportunities. The operations of block 1715 may be performed in accordance with examples as disclosed herein. In some examples, aspects of the operations of 1715 may be performed by an SSB component 1335 as described with reference to FIG. 13.

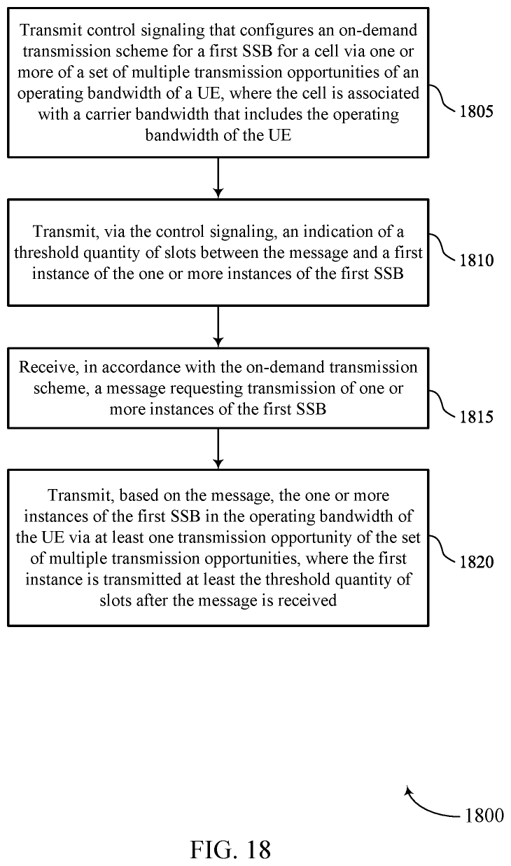

FIG. 18 shows a flowchart illustrating a method 1800 that supports on-demand NCD SSB transmission in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting control signaling that configures an on-demand transmission scheme for a first SSB for a cell via one or more of a set of multiple transmission opportunities of an operating bandwidth of a UE, where the cell is associated with a carrier bandwidth that includes the operating bandwidth of the UE. The operations of block 1805 may be performed in accordance with examples as disclosed herein. In some examples, aspects of the operations of 1805 may be performed by a control signal component 1325 as described with reference to FIG. 13.

At 1810, the method may include transmitting, via the control signaling, an indication of a threshold quantity of slots between the message and a first instance of the one or more instances of the first SSB. The operations of block 1810 may be performed in accordance with examples as disclosed herein. In some examples, aspects of the operations of 1810 may be performed by a threshold component 1340 as described with reference to FIG. 13.

At 1815, the method may include receiving, in accordance with the on-demand transmission scheme, a message requesting transmission of one or more instances of the first SSB. The operations of block 1815 may be performed in accordance with examples as disclosed herein. In some examples, aspects of the operations of 1815 may be performed by a request component 1330 as described with reference to FIG. 13.

At 1820, the method may include transmitting, based on the message, the one or more instances of the first SSB in the operating bandwidth of the UE via at least one transmission opportunity of the set of multiple transmission opportunities, where the first instance is transmitted at least the threshold quantity of slots after the message is received. The operations of block 1820 may be performed in accordance with examples as disclosed herein. In some examples, aspects of the operations of 1820 may be performed by an SSB component 1335 as described with reference to FIG. 13.

The following provides an overview of aspects of the present disclosure:

Aspect 1: A method for wireless communication at a UE, comprising: receiving control signaling that configures an on-demand transmission scheme for a first SSB for a cell via one or more of a plurality of transmission opportunities of an operating bandwidth of the UE, wherein the cell is associated with a carrier bandwidth that includes the operating bandwidth of the UE; transmitting, based at least in part on the control signaling, a message requesting transmission of one or more instances of the first SSB; and receiving, based at least in part on the message, the one or more instances of the first SSB in the operating bandwidth of the UE via at least one transmission opportunity of the plurality of transmission opportunities.

Aspect 2: The method of aspect 1, wherein receiving the control signaling comprises: receiving, via the control signaling, an indication of a quantity of slots between the message and a first instance of the one or more instances of the first SSB, wherein the first instance is received at least the quantity of slots after the message is transmitted.

Aspect 3: The method of any of aspects 1 through 2, wherein transmitting the message comprises: transmitting, via the message, an indication of a quantity of instances requested by the UE, wherein the one or more instances of the first SSB comprise the quantity of instances based at least in part on the message.

Aspect 4: The method of any of aspects 1 through 2, wherein transmitting the message comprises: transmitting, via the message, a selection request that requests for a network entity to select a default quantity of the one or more instances, wherein the one or more instances comprise the default quantity of instances based at least in part on the selection request.

Aspect 5: The method of aspect 4, wherein receiving the control signaling comprises: receiving, via the control signaling, an indication of the default quantity of instances of the first SSB.

Aspect 6: The method of aspect 4, wherein, receiving the one or more instances of the first SSB comprises: receiving, via a first set of transmission opportunities from the plurality of transmission opportunities, a plurality of instances of the first SSB based at least in part on the default quantity of instances being associated with a semi-persistent transmission pattern; monitoring a second set of one or more transmission opportunities of the plurality of transmission opportunities; and transitioning, after monitoring a threshold quantity of the second set of one or more transmission opportunities that exclude the first SSB, to periodically monitoring a second frequency in the carrier bandwidth for a second SSB that is associated with system information of the cell, the second frequency external to the operating bandwidth of the UE.

Aspect 7: The method of any of aspects 1 through 6, further comprising: transmitting a capability message that indicates a capability of the UE to support on-demand SSB communications, wherein receiving the control signaling is based at least in part on the capability message.

Aspect 8: The method of any of aspects 1 through 7, further comprising: periodically monitoring a second frequency in the carrier bandwidth for a second SSB that is associated with system information of the cell, the second frequency external to the operating bandwidth of the UE, wherein transmitting the message is based at least in part on a change in one or more conditions associated with the second SSB.

Aspect 9: The method of aspect 8, wherein the change in the one or more conditions comprises a timing drift of beams associated with the second SSB, or a change in a beam pair link, or both.

Aspect 10: The method of any of aspects 8 through 9, further comprising: evaluating one or more communication metrics during a first time period based at least in part on monitoring the second frequency for the second SSB; and evaluating the one or more communication metrics during a second time period based at least in part on receiving the one or more instances of the first SSB, wherein the second time period is longer than the first time period.

Aspect 11: The method of any of aspects 1 through 10, further comprising: periodically monitoring, after receiving the one or more instances of the first SSB, a second frequency in the carrier bandwidth for a second SSB that is associated with system information of the cell, the second frequency external to the operating bandwidth of the UE.

Aspect 12: The method of any of aspects 1 through 11, wherein receiving the control signaling comprises: receiving, via the control signaling, an indication of a frequency associated with the first SSB, a periodicity associated with the first SSB, a time offset associated with the first SSB, or any combination thereof, wherein the frequency is within the operating bandwidth of the UE.

Aspect 13: The method of any of aspects 1 through 12, wherein a logical channel identifier of the message indicates a request for transmission of the one or more instances of the first SSB.

Aspect 14: The method of any of aspects 1 through 13, wherein the control signaling comprises RRC signaling and the message comprises a MAC-CE.

Aspect 15: The method of any of aspects 1 through 14, wherein the first SSB is different from a second SSB that is associated with system information of the cell, the first SSB comprising an NCD-SSB and the second SSB comprising a CD-SSB.

Aspect 16: A method for wireless communication at a network entity, comprising: transmitting control signaling that configures an on-demand transmission scheme for a first SSB for a cell via one or more of a plurality of transmission opportunities of an operating bandwidth of a UE, wherein the cell is associated with a carrier bandwidth that includes the operating bandwidth of the UE; receiving, based at least in part on the control signaling, a message requesting transmission of one or more instances of the first SSB; and transmitting, based at least in part on the message, the one or more instances of the first SSB in the operating bandwidth of the UE via at least one transmission opportunity of the plurality of transmission opportunities.

Aspect 17: The method of aspect 16, wherein transmitting the control signaling comprises: transmitting, via the control signaling, an indication of a threshold quantity of slots between the message and a first instance of the one or more instances of the first SSB, wherein the first instance is transmitted at least the threshold quantity of slots after the message is received.

Aspect 18: The method of any of aspects 16 through 17, wherein receiving the message comprises: receiving, via the message, an indication of a quantity of instances requested by the UE, wherein the one or more instances of the first SSB comprise the quantity of instances based at least in part on the message.

Aspect 19: The method of any of aspects 16 through 17, wherein receiving the message comprises: receiving, via the message, a selection request that requests for the network entity to select a default quantity of the one or more instances, wherein the one or more instances comprise the default quantity of instances based at least in part on the selection request.

Aspect 20: The method of aspect 19, wherein transmitting the control signaling comprises: transmitting, via the control signaling, an indication of the default quantity of instances of the first SSB.

Aspect 21: The method of aspect 19, wherein transmitting the one or more instances of the first SSB comprises: transmitting, via a first set of transmission opportunities from the plurality of transmission opportunities, a plurality of instances of the first SSB based at least in part on the default quantity of instances being associated with a semi-persistent transmission pattern, wherein the control signaling indicates that the default quantity of instances is associated with the semi-persistent transmission pattern.

Aspect 22: The method of any of aspects 16 through 21, further comprising: receiving a capability message that indicates a capability of the UE to support on-demand SSB communications, wherein transmitting the control signaling is based at least in part on the capability message.

Aspect 23: The method of any of aspects 16 through 22, further comprising: periodically transmitting, via a second frequency in the carrier bandwidth, a second SSB that is associated with system information of the cell, the second frequency external to the operating bandwidth of the UE.

Aspect 24: The method of any of aspects 16 through 23, further comprising: periodically transmitting, after transmitting the one or more instances of the first SSB and via a second frequency in the carrier bandwidth, a second SSB that is associated with system information of the cell, the second frequency external to the operating bandwidth of the UE.

Aspect 25: The method of any of aspects 16 through 24, wherein transmitting the control signaling comprises: transmitting, via the control signaling, an indication of a frequency associated with the first SSB, a periodicity associated with the first SSB, a time offset associated with the first SSB, or any combination thereof, wherein the frequency is within the operating bandwidth of the UE.

Aspect 26: The method of any of aspects 16 through 25, wherein a logical channel identifier of the message indicates a request for transmission of the one or more instances of the first SSB.

Aspect 27: The method of any of aspects 16 through 26, wherein the control signaling comprises RRC signaling and the message comprises a MAC-CE.

Aspect 28: The method of any of aspects 16 through 27, wherein the first SSB is different from a second SSB that is associated with system information of the cell, the first SSB comprising a non-cell defining SSB and the second SSB comprising a cell defining SSB.

Aspect 29: The method of any of aspects 16 through 28, further comprising: refraining from transmitting the first SSB before receiving the message based at least in part on the control signaling configuring the on-demand transmission scheme for the first SSB.

Aspect 30: A UE for wireless communication, comprising one or more memories storing processor-executable code, and one or more processors coupled with the one or more memories and individually or collectively operable to execute the code to cause the UE to perform a method of any of aspects 1 through 15.

Aspect 31: A UE for wireless communication, comprising at least one means for performing a method of any of aspects 1 through 15.

Aspect 32: A non-transitory computer-readable medium storing code for wireless communication, the code comprising instructions executable by a processor to perform a method of any of aspects 1 through 15.

Aspect 33: A network entity for wireless communication, comprising one or more memories storing processor-executable code, and one or more processors coupled with the one or more memories and individually or collectively operable to execute the code to cause the network entity to perform a method of any of aspects 16 through 29.

Aspect 34: A network entity for wireless communication, comprising at least one means for performing a method of any of aspects 16 through 29.

Aspect 35: A non-transitory computer-readable medium storing code for wireless communication, the code comprising instructions executable by a processor to perform a method of any of aspects 16 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that configures an on-demand transmission scheme for a first synchronization signal block for a cell via one or more of a plurality of transmission opportunities of an operating bandwidth of the UE, wherein the cell is associated with a carrier bandwidth that includes the operating bandwidth of the UE;
transmit, in accordance with the on-demand transmission scheme, a message requesting transmission of one or more instances of the first synchronization signal block; and
receive, based at least in part on the message, the one or more instances of the first synchronization signal block in the operating bandwidth of the UE via at least one transmission opportunity of the plurality of transmission opportunities.

2. The UE of claim 1, wherein, to receive the control signaling, the one or more processors are individually or collectively operable to execute the code to cause the UE to:
receive, via the control signaling, an indication of a quantity of slots between the message and a first instance of the one or more instances of the first synchronization signal block, wherein the first instance is received at least the quantity of slots after the message is transmitted.

3. The UE of claim 1, wherein, to transmit the message, the one or more processors are individually or collectively operable to execute the code to cause the UE to:
transmit, via the message, an indication of a quantity of instances requested by the UE, wherein the one or more instances of the first synchronization signal block comprise the quantity of instances based at least in part on the message.

4. The UE of claim 1, wherein, to transmit the message, the one or more processors are individually or collectively operable to execute the code to cause the UE to:
transmit, via the message, a selection request that requests for a network entity to select a default quantity of the one or more instances, wherein the one or more instances comprise the default quantity of instances based at least in part on the selection request.

5. The UE of claim 4, wherein, to receive the control signaling, the one or more processors are individually or collectively operable to execute the code to cause the UE to:
receive, via the control signaling, an indication of the default quantity of instances of the first synchronization signal block.

6. The UE of claim 4, wherein, to receive the one or more instances of the first synchronization signal block, the one or more processors are individually or collectively operable to execute the code to cause the UE to:
receive, via a first set of transmission opportunities from the plurality of transmission opportunities, a plurality of instances of the first synchronization signal block based at least in part on the default quantity of instances being associated with a semi-persistent transmission pattern;
monitor a second set of one or more transmission opportunities of the plurality of transmission opportunities; and
transition, after monitoring a threshold quantity of the second set of one or more transmission opportunities that exclude the first synchronization signal block, to periodically monitoring a second frequency in the carrier bandwidth for a second synchronization signal block that is associated with system information of the cell, the second frequency external to the operating bandwidth of the UE.

7. The UE of claim 1, wherein the one or more processors are individually or collectively further operable to execute the code to cause the UE to:
transmit a capability message that indicates a capability of the UE to support on-demand synchronization signal block communications, wherein receiving the control signaling is based at least in part on the capability message.

8. The UE of claim 1, wherein the one or more processors are individually or collectively further operable to execute the code to cause the UE to:
periodically monitor a second frequency in the carrier bandwidth for a second synchronization signal block that is associated with system information of the cell, the second frequency external to the operating bandwidth of the UE, wherein transmitting the message is based at least in part on a change in one or more conditions associated with the second synchronization signal block.

9. The UE of claim 8, wherein the change in the one or more conditions comprises a timing drift of beams associated with the second synchronization signal block, or a change in a beam pair link, or both.

10. The UE of claim 8, wherein the one or more processors are individually or collectively further operable to execute the code to cause the UE to:
evaluate one or more communication metrics during a first time period based at least in part on monitoring the second frequency for the second synchronization signal block; and
evaluate the one or more communication metrics during a second time period based at least in part on receiving the one or more instances of the first synchronization signal block, wherein the second time period is longer than the first time period.

11. The UE of claim 1, wherein the one or more processors are individually or collectively further operable to execute the code to cause the UE to:
periodically monitor, after receiving the one or more instances of the first synchronization signal block, a second frequency in the carrier bandwidth for a second synchronization signal block that is associated with system information of the cell, the second frequency external to the operating bandwidth of the UE.

12. The UE of claim 1, wherein, to receive the control signaling, the one or more processors are individually or collectively operable to execute the code to cause the UE to:
receive, via the control signaling, an indication of a frequency associated with the first synchronization signal block, a periodicity associated with the first synchronization signal block, a time offset associated with the first synchronization signal block, or any combination thereof, wherein the frequency is within the operating bandwidth of the UE.

13. The UE of claim 1, wherein a logical channel identifier of the message indicates a request for transmission of the one or more instances of the first synchronization signal block.

14. The UE of claim 1, wherein the control signaling comprises radio resource control signaling and the message comprises a medium access control-control element.

15. The UE of claim 1, wherein the first synchronization signal block is different from a second synchronization signal block that is associated with system information of the cell, the first synchronization signal block comprising a non-cell defining synchronization signal block and the second synchronization signal block comprising a cell defining synchronization signal block.

16. A network entity, comprising:
one or more memories storing processor-executable code; and
one or more processors coupled with the one or more memories and individually or collectively operable to execute the code to cause the network entity to:
transmit control signaling that configures an on-demand transmission scheme for a first synchronization signal block for a cell via one or more of a plurality of transmission opportunities of an operating bandwidth of a user equipment (UE), wherein the cell is associated with a carrier bandwidth that includes the operating bandwidth of the UE;
receive, in accordance with the on-demand transmission scheme, a message requesting transmission of one or more instances of the first synchronization signal block; and
transmit, based at least in part on the message, the one or more instances of the first synchronization signal block in the operating bandwidth of the UE via at least one transmission opportunity of the plurality of transmission opportunities.

17. The network entity of claim 16, wherein, to transmit the control signaling, the one or more processors are individually or collectively operable to execute the code to cause the network entity to:
transmit, via the control signaling, an indication of a threshold quantity of slots between the message and a first instance of the one or more instances of the first synchronization signal block, wherein the first instance is transmitted at least the threshold quantity of slots after the message is received.

18. The network entity of claim 16, wherein, to receive the message, the one or more processors are individually or collectively operable to execute the code to cause the network entity to:
receive, via the message, an indication of a quantity of instances requested by the UE, wherein the one or more instances of the first synchronization signal block comprise the quantity of instances based at least in part on the message.

19. The network entity of claim 16, wherein, to receive the message, the one or more processors are individually or collectively operable to execute the code to cause the network entity to:
receive, via the message, a selection request that requests for the network entity to select a default quantity of the one or more instances, wherein the one or more instances comprise the default quantity of instances based at least in part on the selection request.

20. The network entity of claim 19, wherein, to transmit the control signaling, the one or more processors are individually or collectively operable to execute the code to cause the network entity to:
transmit, via the control signaling, an indication of the default quantity of instances of the first synchronization signal block.

21. The network entity of claim 19, wherein, to transmit the one or more instances of the first synchronization signal block, the one or more processors are individually or collectively operable to execute the code to cause the network entity to:
transmit, via a first set of transmission opportunities from the plurality of transmission opportunities, a plurality of instances of the first synchronization signal block based at least in part on the default quantity of instances being associated with a semi-persistent transmission pattern, wherein the control signaling indicates that the default quantity of instances is associated with the semi-persistent transmission pattern.

22. The network entity of claim 16, wherein the one or more processors are individually or collectively further operable to execute the code to cause the network entity to:
receive a capability message that indicates a capability of the UE to support on-demand synchronization signal block communications, wherein transmitting the control signaling is based at least in part on the capability message.

23. The network entity of claim 16, wherein the one or more processors are individually or collectively further operable to execute the code to cause the network entity to:
periodically transmit, via a second frequency in the carrier bandwidth, a second synchronization signal block that is associated with system information of the cell, the second frequency external to the operating bandwidth of the UE.

24. The network entity of claim 16, wherein the one or more processors are individually or collectively further operable to execute the code to cause the network entity to:
periodically transmit, after transmitting the one or more instances of the first synchronization signal block and via a second frequency in the carrier bandwidth, a second synchronization signal block that is associated with system information of the cell, the second frequency external to the operating bandwidth of the UE.

25. The network entity of claim 16, wherein, to transmit the control signaling, the one or more processors are individually or collectively operable to execute the code to cause the network entity to:
transmit, via the control signaling, an indication of a frequency associated with the first synchronization signal block, a periodicity associated with the first synchronization signal block, a time offset associated with the first synchronization signal block, or any combination thereof, wherein the frequency is within the operating bandwidth of the UE.

26. The network entity of claim 16, wherein the one or more processors are individually or collectively further operable to execute the code to cause the network entity to:
refrain from transmitting the first synchronization signal block before receiving the message based at least in part on the control signaling enabling the on-demand transmission scheme for the first synchronization signal block.

27. A method for wireless communication at a user equipment (UE), comprising:
receiving control signaling that configures an on-demand transmission scheme for a first synchronization signal block for a cell via one or more of a plurality of transmission opportunities of an operating bandwidth of the UE, wherein the cell is associated with a carrier bandwidth that includes the operating bandwidth of the UE;
transmitting, in accordance with the on-demand transmission scheme, a message requesting transmission of one or more instances of the first synchronization signal block; and
receiving, based at least in part on the message, the one or more instances of the first synchronization signal block in the operating bandwidth of the UE via at least one transmission opportunity of the plurality of transmission opportunities.

28. The method of claim 27, wherein receiving the control signaling comprises:
receiving, via the control signaling, an indication of a quantity of slots between the message and a first instance of the one or more instances of the first synchronization signal block, wherein the first instance is received at least the quantity of slots after the message is transmitted.

29. A method for wireless communication at a network entity, comprising:
transmitting control signaling that configures an on-demand transmission scheme for a first synchronization signal block for a cell via one or more of a plurality of transmission opportunities of an operating bandwidth of a user equipment (UE), wherein the cell is associated with a carrier bandwidth that includes the operating bandwidth of the UE;
receiving, in accordance with the on-demand transmission scheme, a message requesting transmission of one or more instances of the first synchronization signal block; and
transmitting, based at least in part on the message, the one or more instances of the first synchronization signal block in the operating bandwidth of the UE via at least one transmission opportunity of the plurality of transmission opportunities.

30. The method of claim 29, wherein transmitting the control signaling comprises:
transmitting, via the control signaling, an indication of a threshold quantity of slots between the message and a first instance of the one or more instances of the first synchronization signal block, wherein the first instance is transmitted at least the threshold quantity of slots after the message is received.
